(19) United States
(12) Patent Application Publication
(10) Pub. No.: US 2007/0284345 A1
(43) Pub. Date: Dec. 13, 2007

(54) SEMICONDUCTOR CUTTING DEVICE, SEMICONDUCTOR CUTTING METHOD, SEMICONDUCTOR CUTTING SYSTEM, LASER CUTTING DEVICE AND LASER CUTTING METHOD

(76) Inventors: Syuji ANDO, Chikuma-shi (JP); Shigeyuki UCHIYAMA, Chikuma-shi (JP); Tatsushi OGUCHI, Chikuma-shi (JP)

Correspondence Address: MORGAN & FINNEGAN, L.L.P., 3 WORLD FINANCIAL CENTER, NEW YORK, NY, 10281-2101, US

(21) Appl. No.: 11/758,883

(22) Filed: Jun. 6, 2007

(30) Foreign Application Priority Data
Jun. 8, 2006 (JP) 2006-160320
Jun. 8, 2006 (JP) 2006-160321
Jun. 8, 2006 (JP) 2006-160322
Jul. 19, 2006 (JP) 2006-197473
Jul. 25, 2006 (JP) 2006-201596

(51) Int. Cl. B23K 26/38; B23K 26/14

(52) U.S. Cl. 219/121.67; 219/121.8; 219/121.84; 219/121.82

(57) ABSTRACT

A semiconductor cutting apparatus is disclosed which is capable of reducing an inclination of a cutting section by a laser beam of a semiconductor substrate without extending the distance from the semiconductor substrate to a laser scanning center. The apparatus includes a laser oscillator, a transport mechanism causing a semiconductor substrate and the laser oscillator to relatively move, and a controller controlling the laser oscillator and the transport mechanism. When a plurality of semiconductor device regions each being surrounded by a predetermined cutting line are provided in the semiconductor substrate, the controller controls the transport mechanism such that a scanning center of the laser beam of the laser oscillator is located above a position inner than the predetermined cutting line of each semiconductor device region and causes the laser oscillator to perform the scanning of the laser beam along the predetermined cutting line of the semiconductor device region.

This application claims the right of priority under 35 U.S.C. §119 based on Japanese Patent Applications Nos. 2006-160320, filed on Jun. 8, 2006, 2006-160321, filed on Jun. 8, 2006, 2006-160322, filed on Jun. 8, 2006, 2006-197473, filed on Jul. 19, 2006, and 2006-201596, filed on Jul. 25, 2006, and each of which is hereby incorporated by reference herein in its entirety as if fully set forth herein.

### BACKGROUND OF THE INVENTION

The present invention relates to a cutting apparatus which cut out a workpiece such as an IC chip and a memory card from a semiconductor substrate.

As a method of cutting a semiconductor substrate formed with a plurality of semiconductor device region such as a BGA (ball grid array) and a CSP (chip size package) along a predetermined cutting line so that individual semiconductor device is cut out, Japanese Patent Laid-Open No. 2005-142303 and Japanese Patent Laid-Open No. 2005-238246 disclose a cutting method using a laser beam.

In the cutting method using the laser beam, the laser beam is scanned along the predetermined cutting line by using scanning means such as a galvanomirror, so that the semiconductor substrate can be cut along the predetermined cutting lines of all the semiconductor device regions without moving the semiconductor substrate and a stage holding the substrate or a laser oscillator.

However, when a laser scanning is performed along the predetermined cutting lines of all the semiconductor device regions with a position fixed at one place taken as a scanning center of the laser beam, more away from the scanning center is, more larger is a taper (inclination) given to the cutting section.

To make the taper of the cutting section smaller, it is conceivable to distance the scanning center from the semiconductor substrate. However, when the scanning center is away from the semiconductor substrate, the necessity of increasing the laser output arises, and the scanning position accuracy of the laser beam is deteriorated. The increase in the laser output leads to the increase in the size of a laser oscillator and the high cost. Further, when the scanning position accuracy is deteriorated, the cut section becomes coarse, and the size management of the semiconductor device to be cut out becomes difficult.

Further, a method of cutting the semiconductor substrate along the predetermined cutting line so as to cut out the individual semiconductor device includes a method of using a cutting blade such as a diamond blade (see Japanese Patent Laid-Open No. 2003-163180)

In the cutting method using the cutting blade, high speed cutting of the semiconductor substrate is made possible, and at the same time, the cutting section is generally finished smooth, that is, finished high grade. Hence, a cutting apparatus using the cutting blade has been often used to cut out the semiconductor device in case the predetermined cutting line comprises only a linear line such as a rectangle.

However, the predetermined cutting line sometimes includes an odd-shaped line portion which is not in the shape of a continuous straight line such as a curve portion and a convexoconcave line portion. Such an odd-shape line portion is unable to be cut by the cutting blade. Hence, to cut out the semiconductor device including the odd-shape line portion, the adoption of the cutting method using the laser beam or water jet disclosed in Japanese Patent Laid-Open No. 2005-142303 and Japanese Patent Laid-Open No. 2005-238246 is considered.

However, the method of using the water jet, as compared to the method of using the cutting blade, is slow in cutting speed. Further, the semiconductor device immediately after the completion of the cutting may fly in any direction by the force of the water jet.

Further, in the method of using the laser beam, it is possible to increase the cutting speed by setting the strength of the laser beam high. However, when the strength of the laser beam is set high, the semiconductor may change its nature. Further, when an attempt is made to complete the cutting by the laser beam irradiation in a single time, the cutting section becomes coarse. It is, thus, conceivable that the laser beam cutting to every predetermined depth on the predetermined cutting line is repeated in a plurality of times so as to perform the cutting of the predetermined cutting line. However, when all the predetermined cutting lines (entire periphery of the semiconductor device) are cut by this method, the cutting processing speed often becomes slow.

Further, as described above in the cutting method using the laser beam, it is possible to cut the semiconductor substrate by the laser beam scan in a single time by setting the output (strength) of the laser beam high.

However, when an attempt is made to complete the cutting by the laser beam scan in a single time, the cutting section becomes coarse. Further, in this case, even when the output of the laser beam is high, it is necessary to make the cutting (scan) speed slow to some extent. Hence, an amount of heat generated accompanied with the laser beam irradiation may be increased, and the cutting width becomes larger or the semiconductor changes in its nature (inner element is broken).

When the semiconductor substrate has a plurality of layers mutually different in the materials, it is a prevailing practice that the output of the laser beam is aligned with the layer most difficult to cut (for example, a glass epoxy print substrate layer when the semiconductor substrate has a package resin layer and the glass epoxy print substrate layer). However, in this method, the coarseness of the cutting sections of the other layers becomes worse than expected and the increase in the cutting width of other layers due to heat becomes noticeable.

Further, in a laser cutting apparatus, so as not to give some damage to the apparatus by the laser beam penetrating the workpiece, the workpiece on the opposite side to the laser oscillator is disposed with a laser receiving member made of a fire-resistance material such as aluminum. Japanese Patent Laid-Open No. 10-328875 discloses a method of adding a damping structure or a scattering reflection structure of the laser beam to the flat laser receiving member disposed in parallel with the workpiece, so that the laser beam reflected by the laser receiving member does not reach the workpiece again.

However, when the laser receiving member is provided with the damping structure or the scattering reflection structure of the laser beam as disclosed in Japanese Patent Laid-Open No. 10-328875, the structure of the laser receiving member becomes complicated, which leads to the increase in the size of laser receiving member and high cost.

Further, an region disposed with the laser receiving member as described above sometimes becomes the flow path of a dust collection air to remove soot and dust generated by the cutting of the workpiece. However, in the conventional laser cutting apparatus, the soot and dust not removable enough by the dust collection air are adhered to the workpiece and the laser receiving member, thereby necessitating frequent cleaning.

Further, as described above, in the laser cutting apparatus, since processing debris such as soot and dust generated from the workpiece irradiated with the laser beam adheres to the workpiece, it is necessary to clean the workpiece after the cutting processing.

However, when an amount of the processing debris generated from the workpiece is great and the adhering amount thereof is also great, there are often the cases where the cleaning after the cutting processing takes long time and the processing debris not removable by the cleaning is left remain.

Particularly, since the laser beam penetrates the workpiece from its surface side to the back surface side and cuts the same, at the back surface side also, the processing debris is generated, and adheres to the back surface of the workpiece. Consequently, cleaning after the cutting processing must be performed at both surfaces of the workpiece, and there is a possibility that this becomes disadvantageous in time and the remaining amount of the processing debris increases.

Further, though the laser beam is emitted from the light emission surface (lens surface) of the laser oscillator toward the workpiece, when the processing debris generated from the workpiece adheres to the light emission surface, an appropriate laser irradiation is unable to be performed.

### BRIEF SUMMARY OF THE INVENTION

The present invention provides a semiconductor cutting apparatus capable of reducing an inclination of a cutting section by a laser beam of a semiconductor substrate without extending the distance from the semiconductor substrate to a laser scanning center.

Further, the present invention provides a semiconductor device cutting system capable of performing cutting of a semiconductor device including an odd-shaped line portion from the semiconductor substrate at a high speed, and moreover, securing a high grade cutting section.

Further, the present invention provides a semiconductor cutting apparatus capable of securing a high grade cutting section by cutting a semiconductor substrate with a laser beam and suppressing an increase in cutting width, and moreover, performing the cutting at a high speed, while preventing changes in the nature of the semiconductor.

Further, the present invention provides a laser cutting apparatus capable of avoiding giving damage to a workpiece by a laser beam reflected by a laser receiving member by using the laser receiving member of a simple structure.

Further, the present invention provides a laser cutting apparatus capable of improving a removal function of soot and dust by dust collection air by using a laser receiving member.

Further, the present invention provides a laser cutting apparatus capable of suppressing adherence to both surfaces of a workpiece of a processing debris generated from the workpiece to be cut by a laser beam.

As one aspect, the present invention provides a semiconductor cutting apparatus which cuts a semiconductor substrate to cut out a semiconductor device with a laser beam. The apparatus includes a laser oscillator capable of outputting and scanning the laser beam, a transport mechanism which causes the semiconductor substrate and the laser oscillator to relatively move, and a controller which controls the laser oscillator and the transport mechanism. When a plurality of semiconductor device regions each being surrounded by a predetermined cutting line are provided in the semiconductor substrate, the controller controls the transport mechanism such that a scanning center of the laser beam of the laser oscillator is located above a position inner than the predetermined cutting line of each semiconductor device region and causes the laser oscillator to perform the scanning of the laser beam along the predetermined cutting line of the semiconductor device region.

As another aspect, the present invention provides a semiconductor device cutting system which cuts a semiconductor substrate along a predetermined cutting line to cut out a semiconductor device, the predetermined cutting line comprising a first portion having a straight line shape and a second portion having a shape different from the first portion. The system includes a blade cutting part which cuts the semiconductor substrate along the first portion with a cutting blade, and a laser cutting part which cuts the semiconductor substrate along the second portion with a laser beam.

As another aspect, the present invention provides a semiconductor cutting apparatus which cuts a semiconductor substrate having a plurality of semiconductor device regions with a laser beam. The apparatus includes a laser oscillator capable of outputting and scanning a laser beam, and a controller which controls the laser oscillator so as to scan the laser beam along a predetermined cutting line of each semiconductor device region provided in the semiconductor substrate. The semiconductor substrate includes a plurality of layers mutually different in materials. The controller changes a parameter of the laser beam or the number of scanning times for each layer and causes the laser oscillator to perform an orbital scanning of the laser beam in a plurality of times for the same predetermined cutting line.

As still another aspect, the present invention provides a laser cutting apparatus which cuts a workpiece set in a workpiece setting region with a laser beam. The apparatus includes a laser oscillator which emits a laser beam, and a laser receiving member which receives the laser beam having passed through the workpiece setting region. The laser receiving member includes a laser receiving surface which approaches the workpiece setting region from an outer portion to an inner portion of the laser receiving member.

As further still another aspect, the present invention provides a laser cutting apparatus which cuts a workpiece set in a workpiece setting region with a laser beam. The apparatus includes a laser oscillator capable of outputting and scanning a laser beam, and a laser receiving member which receives the laser beam having passed through the workpiece setting region. The laser receiving member includes a laser receiving surface which approaches the workpiece setting region as approaching a scanning center axis of the laser beam.

As yet another aspect, the present invention provides a laser cutting apparatus which cuts a workpiece set in a workpiece setting region with a laser beam. The apparatus includes a laser oscillator which emits a laser beam, and a cover member which surrounds a laser irradiation space between a laser emitting surface from which the laser beam emerges in the laser oscillator and the workpiece setting region. The cover member includes a first air intake port for taking in a first air and an air exhaust port for exhausting the first air. The first air intake port and the air exhaust port are provided in the cover member at positions opposite to each other across the workpiece setting region and closer to the workpiece setting region than to the laser emitting surface. A flow path for a second air is formed on the opposite side to the laser irradiation space with respect to the workpiece setting region.

Further objects or features of the present invention will become apparent from the preferred embodiments described with reference to the following drawings.

### BRIEF DESCRIPTION OF THE DRAWINGS

FIG. 1 is a top plan view showing the configuration of a semiconductor cutting system which is a first embodiment of the present invention;

FIG. 2 is a front view of a laser oscillator provided in a laser cutting part in the first embodiment;

FIG. 3 is a schematic illustration showing the configuration of a laser oscillator in the first embodiment;

FIG. 4 is a side view showing a state of a substrate cutting at a blade cutting part in the first embodiment;

FIG. 5 is a top plan view showing a memory card substrate and a predetermined cutting line in the first embodiment;

FIG. 6 is a top plan view showing a memory card substrate cut in corner portions in the first embodiment;

FIG. 7 is a top plan view showing the memory card substrate cut in straight line portions and individualized memory cards in the first embodiment;

FIGS. 8A and 8B are front views showing a state of a laser cutting of the substrate in the first embodiment;

FIGS. 9 and 10 are front views showing a state of the laser cutting of the substrate different from the first embodiment;

FIG. 11 is a front view showing a cutting groove at a laser stepwise cutting of the substrate in the first embodiment;

FIG. 12 is an enlarged view showing the cutting groove at the laser stepwise cutting of the substrate in the first embodiment;

FIG. 13 is a front view showing the cutting groove at the laser batch cutting of the substrate;

FIG. 14 is an enlarged view showing the cutting groove at the laser batch cutting of the substrate;

FIGS. 15 and 16 are enlarged views showing a state of laser stepwise cutting of a package resin layer and a printed board layer in the first embodiment;

FIG. 17 is an enlarged view showing a state of the laser batch cutting of the package resin layer and the printed board layer;

FIG. 18A is a top plan enlarged view showing a cutting result of the substrate at a high Q switch frequency;

FIG. 18B is a sectional enlarged view showing a cutting result of the substrate at a high Q switch frequency;

FIG. 19A is a top plan enlarged view showing a cutting result of the substrate at a low Q switch frequency;

FIG. 19B is a sectional enlarged view showing a cutting result of the substrate at a low Q switch frequency;

FIG. 20 is a flowchart showing the procedure of the substrate cutting processing of the first embodiment;

FIG. 21 is a top plan view showing the configuration of a semiconductor cutting system which is a second embodiment of the present invention;

FIG. 22 is a top plan view showing the configuration of a semiconductor cutting system which is a third embodiment of the present invention;

FIG. 23A is a top plan enlarged view showing a shape of a predetermined cutting line in a fourth embodiment of the present invention;

FIG. 23B is a top plan enlarged view showing another shape of a predetermined cutting line in a fourth embodiment of the present invention;

FIG. 24 is a top plan view of a laser cutting apparatus which is a fifth embodiment of the present invention;

FIG. 25 is a sectional view of a movable stage in the laser cutting apparatus of a fifth embodiment;

FIG. 26 is a schematic diagram showing the configuration of a laser oscillator in the laser cutting apparatus of the fifth embodiment;

FIG. 27 is a top plan view of the semiconductor substrate to be cut by the laser cutting apparatus of the fifth embodiment;

FIG. 28 is a view to explain a reaction of a laser receiving member in the laser cutting apparatus of the fifth embodiment;

FIG. 29 is a sectional view of a movable stage in the laser cutting apparatus of the fifth embodiment;

FIG. 30 is a top view and a side view showing a shape example of a laser receiving member in the laser cutting apparatus of the fifth embodiment;

FIG. 31 is a top view and a side view showing another shape example of the laser receiving member in the laser cutting apparatus of the fifth embodiment;

FIG. 32 is a sectional view of a movable stage in a laser cutting apparatus which is a sixth embodiment of the present invention;

FIG. 33 is a top plan view of a laser cutting apparatus which is a seventh embodiment of the present invention;

FIG. 34 is a sectional view of the laser cutting apparatus of the seventh embodiment;

FIG. 35 is a schematic diagram showing the configuration of a laser oscillator in the laser cutting apparatus of the seventh embodiment;

FIG. 36 is a top plan view of a semiconductor substrate to be cut by the laser cutting apparatus of the seventh embodiment;

FIG. 37 is a view showing a modified example in the laser cutting apparatus of the seventh embodiment;

FIG. 38 is a sectional view showing another modified example in the laser cutting apparatus of the seventh embodiment; and

FIG. 39 is a sectional view of the laser cutting apparatus which is an eighth embodiment of the present invention.

### DETAILED DESCRIPTION OF THE PREFERRED EMBODIMENTS

Hereinafter, preferred embodiments of the present invention will be described with reference to the drawings.

### First Embodiment

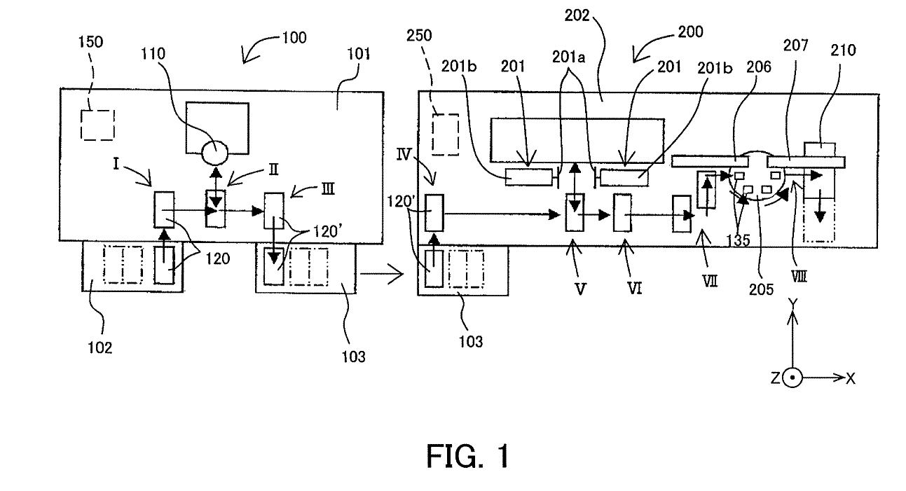

FIG. 1 shows the configuration of a semiconductor cutting system seen from the above, which is a first embodiment of the present invention. In FIG. 1, reference numeral 100 denotes a laser cutting part constituted by a laser cutting processing apparatus, and reference numeral 200 denotes a blade cutting part constituted by a dicing apparatus.

The laser cutting part 100 includes a base 101 and a laser oscillator 110 installed on the base 101. Reference numeral 102 denotes a first substrate magazine with large quantities of semiconductor substrates 120 before laser cutting processing stored therein, and by an unshown first transport mechanism, the semiconductor substrates 120 are transported to a first position I on the base 101 from the first substrate magazine 102 one by one.

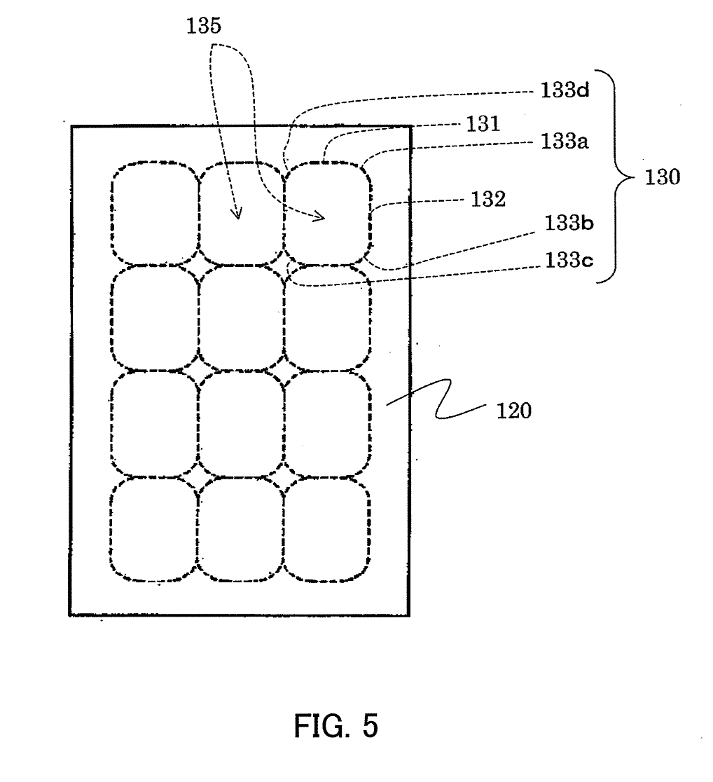

The semiconductor substrate 120 before the cutting processing is shown in FIG. 5. Here, as one of the semiconductor substrates 120, the memory card substrate is shown as an example. The memory card substrate 120 is sealed (coated) by resin on a printed board formed with circuits for a plurality of memory cards after memory chips and controller chips are mounted.

Dotted lines 130 are predetermined cutting lines of the memory card substrate 120. The predetermined cutting line 130 includes a first straight line portion 131 continuously extending in the horizontal direction in the figure, a second straight line portion 132 continuously extending in the vertical direction, and four corner portions 133a to 133d (second portion) having a ¼ arc curve shape as an odd-shaped line portion connecting these first and second straight line portions (first portion) 131 and 132. However, the predetermined cutting line 130 is a virtual line and not actually drawn on the memory card substrate 120, but stored in the memories inside controllers (computers) 150 and 250 provided in the laser cutting part 100 and the blade cutting part 200.

Every single region 135 surrounded by the two straight line portions 131 and 132 and four corner portions 133a to 133d is a semiconductor device region directly serving as the memory card as the individual semiconductor by cutting the substrate 120 along the predetermined cutting line 130. Hereinafter, every semiconductor device region before cutting is referred to as a memory card region 135. As the semiconductor device, it may be a device other than the memory card, for example, a chip element such as IC and LSI.

The substrate 120 positioned at the first position I is transported to a second position II which is the front of the laser oscillator 110 by an unshown second transport mechanism.

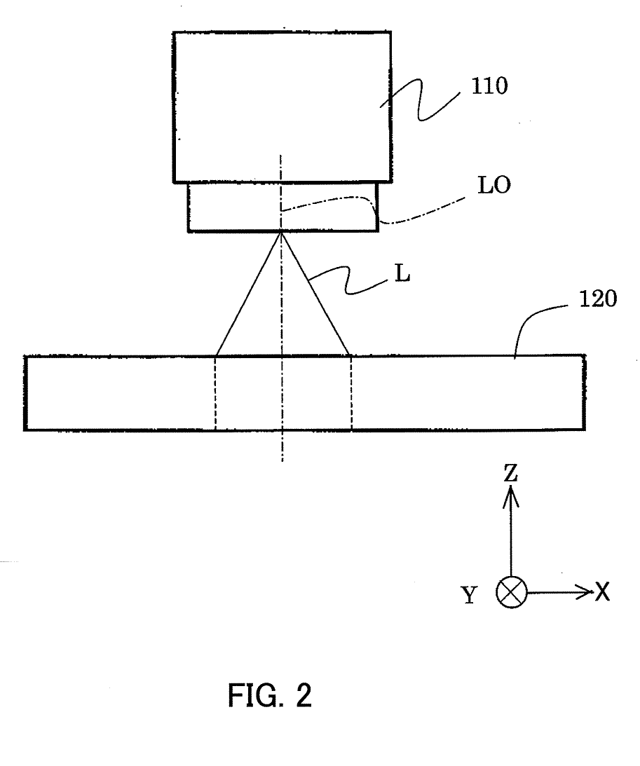

At the second position II, an unshown movable stage is provided, and the substrate 120 transported onto the movable stage is fixed thereon by its bottom surface adsorbed by negative pressure. The movable stage, as shown in FIG. 2, is driven such that the center of the memory card region 135 is positioned on a center axis LO of the laser oscillator 110. Hereinafter, this position is referred to as a laser irradiation position.

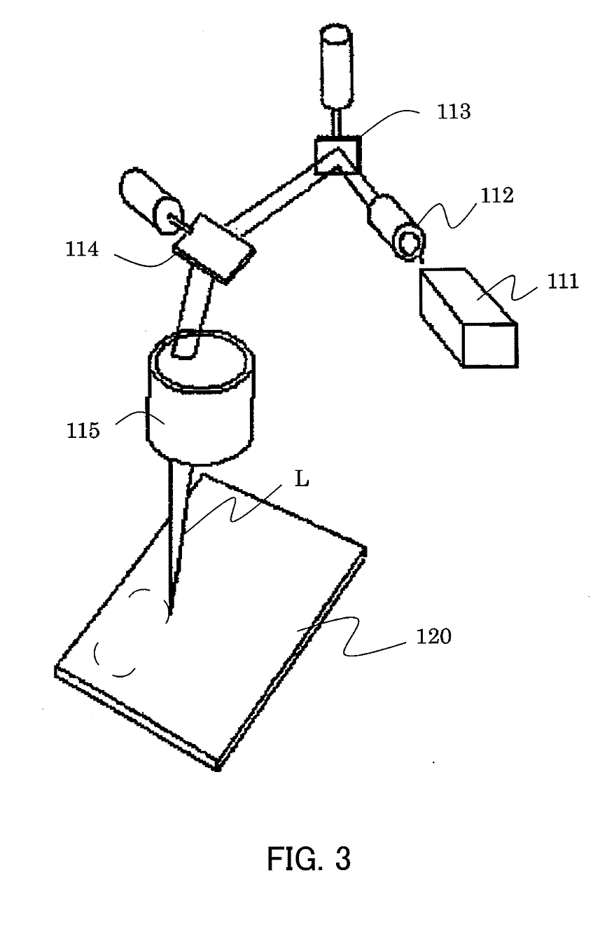

The laser oscillator 110, for example, is configured as shown in FIG. 3. The laser beam emitted from a laser beam source 111 is expanded in light beam diameter by a beam expander 112, and after that, is sequentially reflected by the galvanomirrors 113 and 114 for Y-axis and X-axis as scanning devices. The laser beam reflected by the galvanomirrors 113 and 114 forms a spot-image on the substrate 120 disposed at a cutting processing position by a condensing optical system 115 such as an f-θ lens.

The spot image is scanned in the Y-axis direction (vertical direction in FIG. 5) and the X-axis direction (horizontal direction in FIG. 5) according to the rotation of the galvanomirrors 113 and 114. Hence, controlling the angles of rotation of the galvanomirrors 113 and 114 can move the spot image of the laser beam along the corner portion 133, and as a result, a moving track of the spot image in the substrate 120 is vaporized and melted so as to be cut. Thus, the corner portions 133a to 133d of the memory card 135 can be cut.

That is, in the laser cutting part 100 of the present embodiment, when the four corner portions 113a to 133d of a single memory card region 135 are cut, the laser beam is scanned without moving the substrate 120 in the X-axis direction and the Y-axis direction.

In the present embodiment, as a laser beam source 111, a YAG laser (for example, wavelength:1.06 μm) is used. Further, in the present embodiment, when the substrate 120 with a printed board coated by resin is cut, the pulse irradiation frequency (Q switch frequency), current value, cutting speed and the like of the laser beam are changed with the wavelength of the laser beam kept constant according to the case where the resin portion (package resin layer to be described later) is cut and the case where the printed board portion (printed board layer to be described later) is cut. Further, in the present embodiment, the laser cutting is performed without putting the substrate 120 into a gas atmosphere. As a result, the configuration of the laser cutting part 100 is made simple, and at the same time, different from the laser cutting in the gas atmosphere difficult to perform other than the straight line cutting, the odd-shaped line portion such as a curve can be cut by the scanning of the laser beam (without moving the substrate 120 upon cutting the four corner portions 133a to 133d of the single memory card region 135).

As described above, one card memory region 135 in the substrate 120 has four corner portions 133a to 133d. In the laser cutting part 100 of the present embodiment, the cutting of a predetermined amount (small amount) for each of these four corner portions 133a to 133d, that is, a rotational scanning of the laser beam is performed sequentially, and by repeating this scanning in a plurality of times, each corner portion is completely cut.

Specifically, for example, first, the corner portion 133a is cut by the laser beam by the amount equivalent to 1/10 of the thickness of the substrate 120, and then, the corner portion 133b is also cut by the same amount. Subsequently, the same amount only is cut in order of the corner portions 133c and 133d, and the cutting up to here is taken as a single cutting cycle. By repeating the same cutting cycle ten times, the cutting of the four corner portions 133a to 133d by the laser beam is completed.

In this manner, each corner portion is cut little by little in plurality of times, so that the finish of the cutting section becomes good as compared to the case where the cutting is performed in a single time.

Moreover, after performing a small amount of the cutting of one corner portion, the small amount of the cutting of the next corner is performed, so that the corner portion as the cutting object is sequentially changed. This is because, when the small amount of the cutting of the same corner portion is continuously performed, the quality of the cutting section of the corner portion is deteriorated due to the processing heat. Hence, in the present embodiment, a cooling period is given for each small cutting in each of the four corner portions, so that the cutting section of each corner portion can be made well in quality.

Although a description has been made on the case where each corner portion is cut in 10 times, this is nothing but an example, and the number of times may be other than ten such as five or twenty. Further, the cutting amount at each cycle may be the same or different. In addition, the embodiments of the present invention are not limited to the case where each corner portion is cut in plurality of times, and when the required quality of the cutting section is not so high, each corner portion may be cut in a single time.

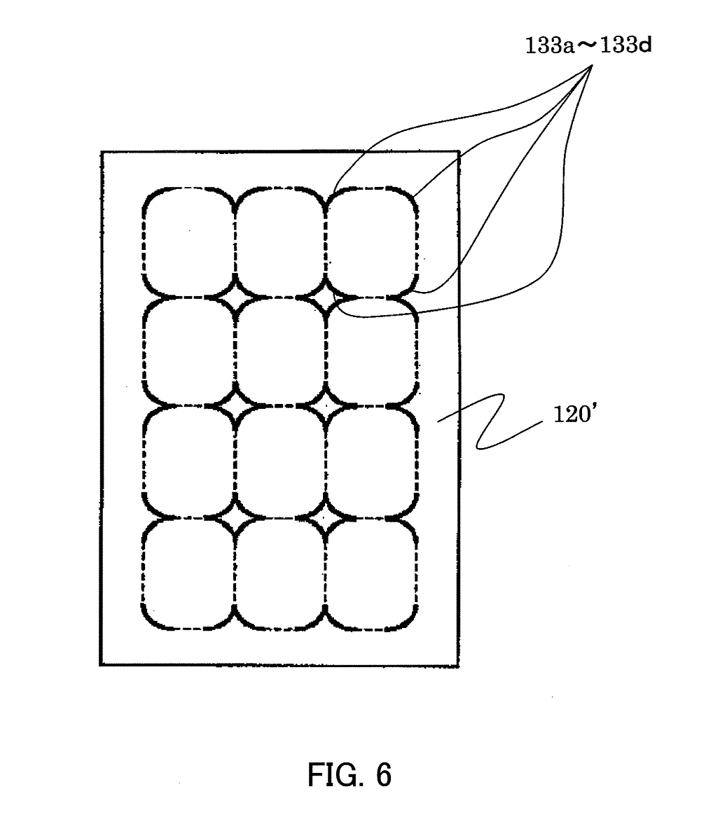

When the cutting of each corner portion of the first memory card region 135 is completed, the movable stage is moved such that the center of the next (second) memory card region 135 is positioned on the center axis LO of the laser oscillator 110. Then, the four corner portions 133a to 133d of the second memory card region 135 are cut by the above described procedure. In this manner, as shown in FIG. 6, the cutting of the corner portions 133a to 133d of all the memory card regions 135 on the substrate 120 is performed. Incidentally, the alignment degree between the center of the memory card region 135 and the center axis LO of the laser oscillator 110 includes not only the case where it is completely aligned, but also the case where it is within a permissible range.

In FIG. 1, a semiconductor substrate 120′ in which the cutting of the corner portions of all the memory card regions 135 is completed is taken out from the second position II (movable stage) to a third position III on the base 101 by an unshown third transport mechanism. At this third position III, the processing debris such as soot adhered on the substrate 120′ by the laser cutting processing is removed by an unshown cleaning mechanism. The cleaned substrate 120′ is stored into a second substrate magazine 103 from the third position III by an unshown fourth transport mechanism.

The substrate 120′ stored into the second substrate magazine 103 is taken out to a fourth position IV on a base 202 of the blade cutting part 200 by an unshown fifth transport mechanism, and further, is transported to a fifth position V on the base 202 by an unshown sixth transport mechanism.

On the fifth position V, an unshown movable stage is provided, and the substrate 120′ transported on the movable stage is fixed thereon by the bottom surface of each memory card region 135 being adsorbed by negative pressure.

On the blade cutting part 200, two cutting blade units 201 are provided. Each cutting blade unit 201 includes a motor 201b and a cutting blade 201a such as a diamond blade attached to the output axis of the motor 201b.

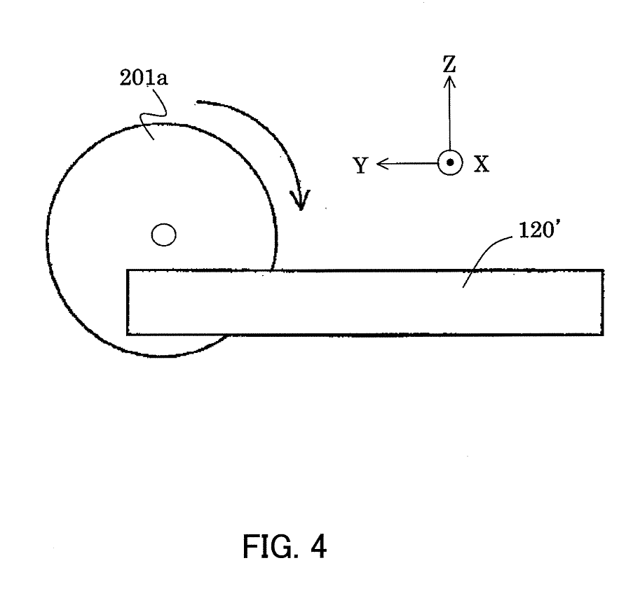

While the two cutting blades 201a are rotated, the movable stage is moved in the Y direction in FIG. 1, so that two second straight line portions 132 in the substrate 120′ are cut simultaneously. This cutting and the shifting of the substrate 120′ (movable stage) in the X direction are repeated, so that all the second straight line portions 132 are cut. FIG. 4 shows a state in which the substrate 120′ (single straight line portion) is cut by the cutting blade 201a in a single time.

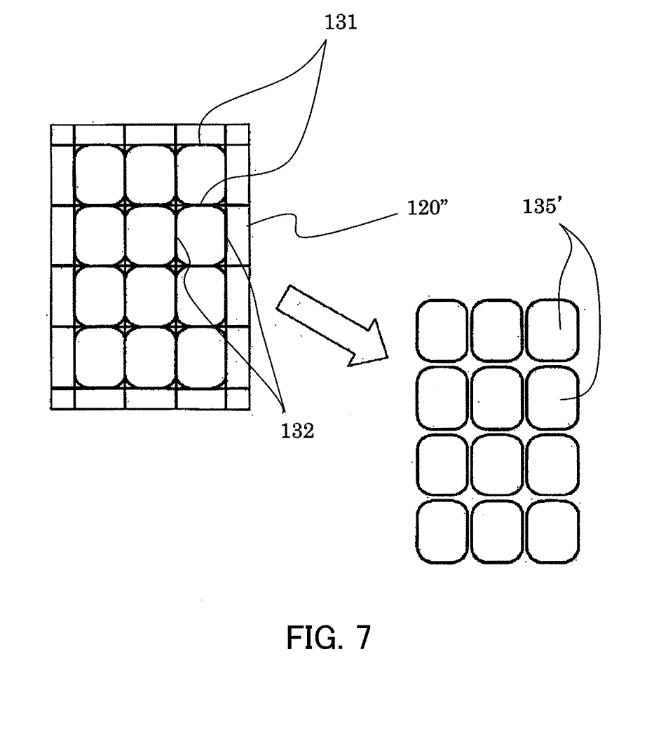

Further, the movable stage is rotated 90 degrees and moved in the Y direction, so that two first straight line portions 131 in the substrate 120′ are cut simultaneously. This cutting and the shifting of the substrate 120′ (movable stage) in the X direction are repeated, so that all the first straight line portions 131 are cut. The substrate 120″ in which the cutting of all the straight line portions 131 and 132 is completed is shown in FIG. 7.

The substrate 120″ is transported to a six position VI on the base 202 from the fifth position V (movable stage) by an unshown seventh transport mechanism, and here, dirt such as the processing debris by the blade cutting is cleaned. After the cleaning, the substrate 120″ is transported to a seventh position VII on the base 202 by an unshown eighth transport mechanism.

On the seventh position VII, a rotation table 205 is provided, and each memory card 135′ (see FIG. 7) cut out from the substrate 120″ is transported onto the rotation table 205 by a ninth transport mechanism 206. Each memory card 135′ moved to an eighth position VIII by the rotation of the rotation table 205 is picked up by a tenth transport mechanism 207, and is stored on a storage tray 210.

The cutting of the straight line portions 131 and 132 by the cutting blade 201a is at a high speed, and moreover, the cutting section is also finished smooth. Consequently, the memory card 135′ finally cut out by the cutting system of the present embodiment can be used as a memory card product as it is without covering it with a member such as a cover or a cap.

The memory card, when inserted into electronic equipment such as a digital camera and mobile phone, has the end face of the straight line portion serving as a push-in guide face, and therefore, a demand for smooth finishing is high for the end surface. Further, the corner portion frequently touched by the hand by a user is desirable to be curve-shaped rather than square-shaped. The present embodiment can cut out and process a memory card satisfying such a demand at a high speed.

In the present embodiment, among the predetermined cutting line 130 of the substrate 120, first, the corner portions 133a to 133d are cut by the laser cutting part 100, and after that, the straight line portions 131 and 132 are cut by the blade cutting part 200. As a result, the substrate 120′ in which the cutting by the laser cutting part 100 is completed can be transported to the blade cutting part 200 with the substrate shape maintained as it is, and an advantage is afforded that its handling is easy.

When the cutting of the straight line portions 131 and 132 by the blade cutting part 200 is performed before the laser cutting, small and scattered substrates (chips) are transported to the laser cutting part 100 from the blade cutting part 200, and the cutting of the corner portions 133a to 133d is performed for small substrate chips, and this makes the handling and the positioning for the laser cutting difficult. However, this does not mean that the cutting by the laser beam after the cutting by the cutting blade is excluded in embodiments of the present invention.

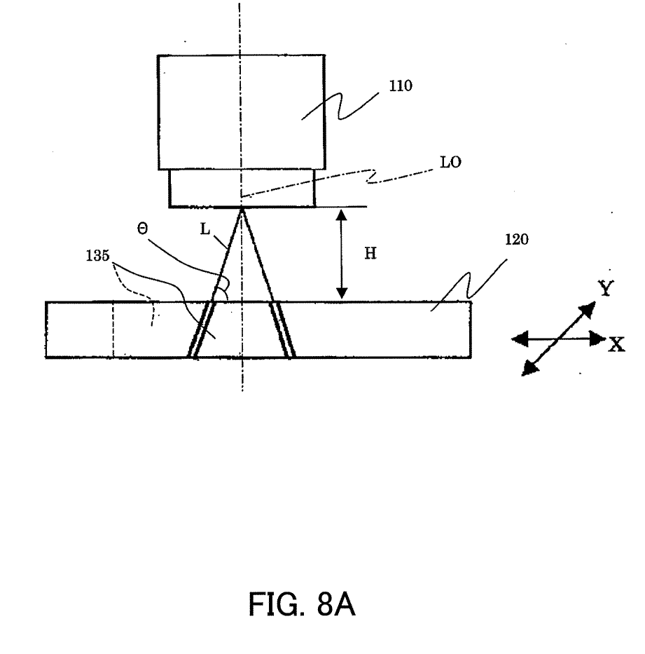

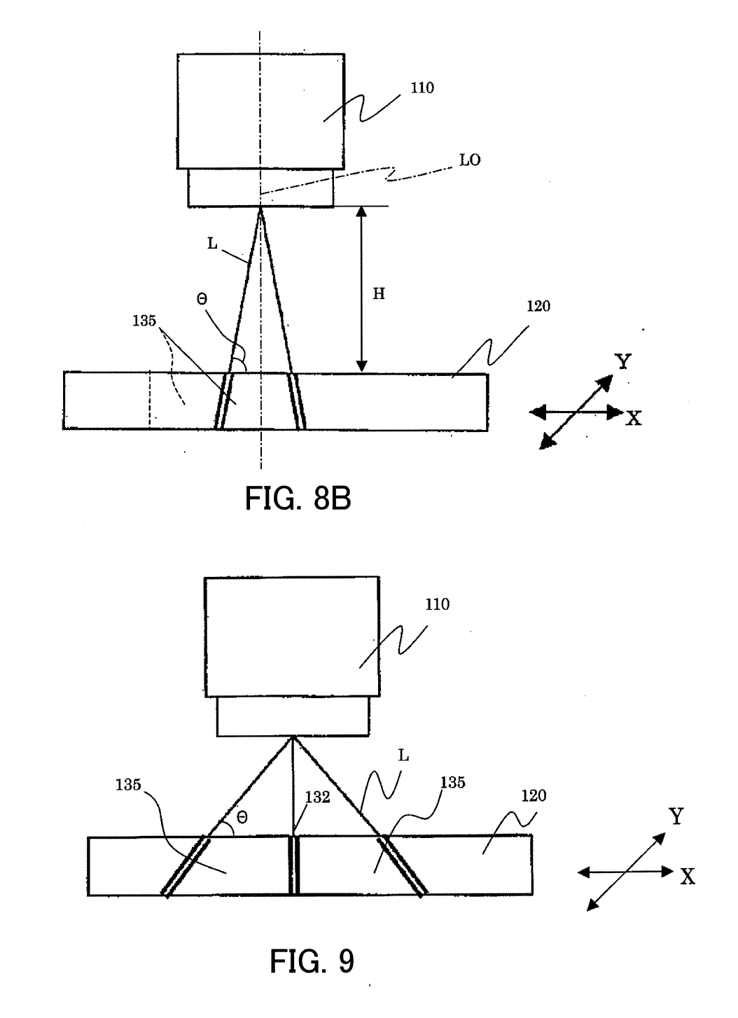

FIGS. 8A and 8B show the details of the cutting processing at the laser cutting part 100 in the present embodiment. As described above, in the present embodiment, the movable state and the substrate 120 are positioned so that the center of each memory card region 135 is aligned with the center axis LO (scanning center of a laser beam L by the galvanomirrors 113 and 114) of the laser oscillator 10. Then, the laser beam L is scanned along the corner portions 133a to 133d of the memory card region 135.

Here, as shown in FIG. 9, assuming that the laser beam L is scanned in a state in which the straight line portion 132 (or 131) between two memory card regions 135 is aligned with the center of the laser oscillator 110, the irradiation angle θ becomes large to a normal to the substrate 120 of the laser beam L scanned in the X direction (or Y direction) from the scanning center, and an inclination (taper) of the cutting section of the corner portion becomes large.

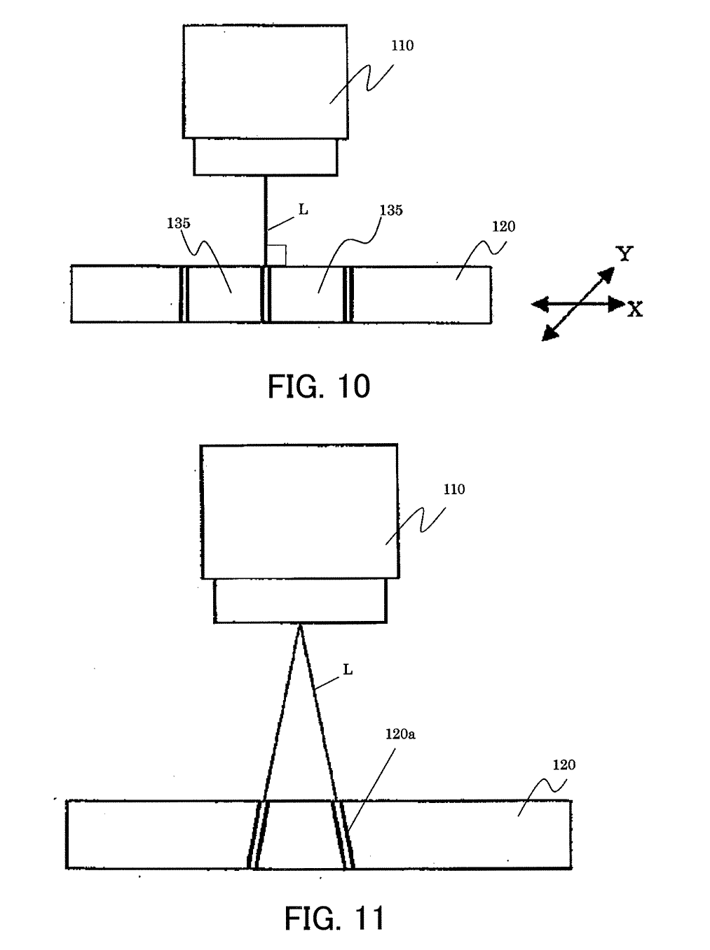

Further, as shown in FIG. 10, in a state in which the laser beam L is irradiated directly below the center of the laser oscillator 10 without scanning the laser beam L, if the substrate 120 is moved in the XY directions by the movable state, while performing the cutting, the irradiation angle θ of the leaser beam L to the normal to the substrate 120 becomes always 0 degree, and no inclination arises on the cutting section of the corner portion. However, in this method, since it is necessary to move the movable stage having a heavy weight or perform an accurate positional control, the processing speed becomes slow as compared to the case where the laser beam is scanned.

Hence, in the present embodiment, as shown in FIG. 8A, upon positioning the substrate 120 so that the center of each memory card region 135 is aligned with the center of the laser oscillator 10, the laser beam L is scanned. As a result, the irradiation angle θ to the normal to the substrate 120 of the laser beam L scanned in the x direction (or y direction) from the scanning center becomes close to 0 degree as compared to the case shown in FIG. 9, and the inclination of the cutting section becomes also small. Moreover, as shown in FIG. 10, as compared to the case where the substrate 120 is moved in the XY directions, while performing the cutting, the cutting processing can be performed at a higher speed.

In this manner, in the present embodiment, an attempt is made to establish compatibility between making the inclination of the cutting sections of the corner portions 133a to 133d of each memory card region 135 small and speeding up of the cutting processing.

Incidentally, as compared to FIG. 8A, FIG. 8B is longer in distance (taller in height) H from the laser oscillator 10 to the substrate 120. In this case, though the strength of the laser beam L becomes larger as compared to the case of FIG. 8A, the irradiation angle θ of the laser beam L to the normal to the substrate 120 becomes closer to 0 degree as compared to that in FIG. 8A, thereby enabling the inclination of the cutting section to be made much smaller. In the present embodiment, according to the output of the laser beam and permissible inclination of the cutting section and quality requirement of the cutting section and the like, a height H from the laser oscillator 110 to the substrate 120 can be arbitrarily selected.

Further, in the present embodiment, though a description will be made on the case where the substrate 120 is cut by the laser beam in a state in which the center of the memory card region 135 is aligned with the center axis (axis passing through the scanning center of the laser beam) LO of the laser oscillator 110, when the shape of the semiconductor device region is complicated and the center is not decided so simply, the scanning center of the laser beam may be positioned above the position inner than the predetermined cutting line such as a barycenter position of the semiconductor device region.

Furthermore, embodiments of the present invention, as shown in FIGS. 9 and 10, do not exclude the case where the laser cutting of the substrate 120 is performed in a state in which the center of the memory card region 135 is out of alignment with the center axis LO of the laser oscillator 110.

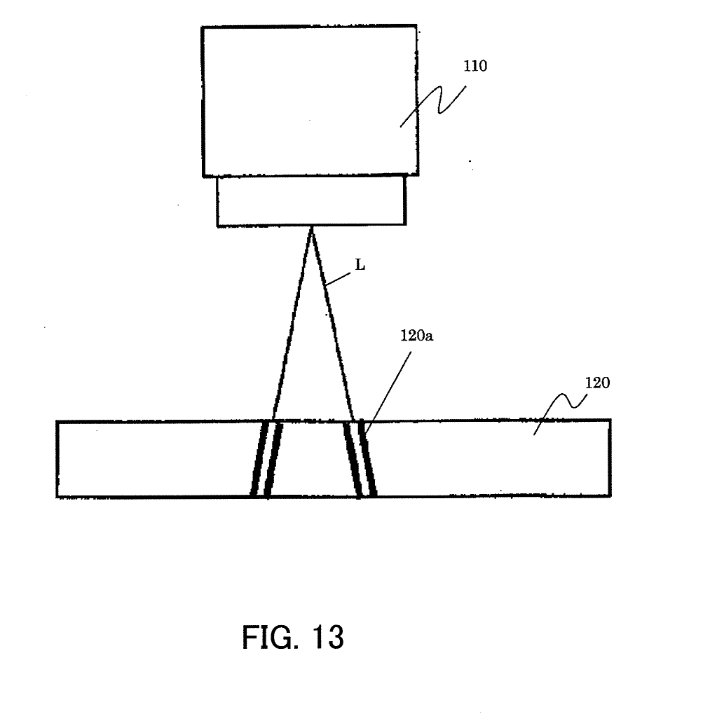

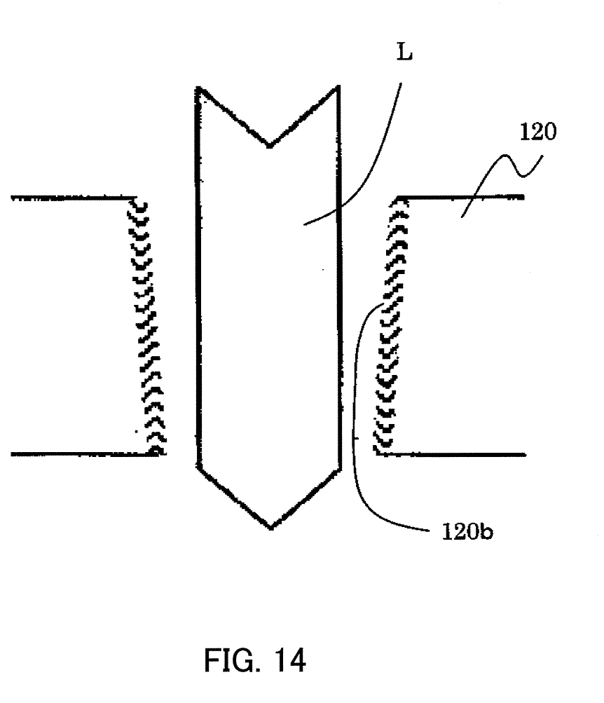

Here, the relationship between the coarseness of the cutting section and the output of the laser beam will be described. FIGS. 13 and 14 show the cases where the substrate 120 is completely cut by the laser irradiation in a single time. To cut the substrate 120 completely by the laser irradiation in a single time, the output of the laser beam L is required to be set larger. In this case, as shown in FIG. 13, the width of the cutting groove 120a melted and created by the laser beam L becomes large, and at the same time, as shown in FIG. 14, the cutting section 120b becomes coarse. Furthermore, this also leads to the increase in the size of the laser oscillator and the laser cutting part (laser cutting apparatus) 100 and high cost thereof accompanied with highly raised output of the laser oscillator.

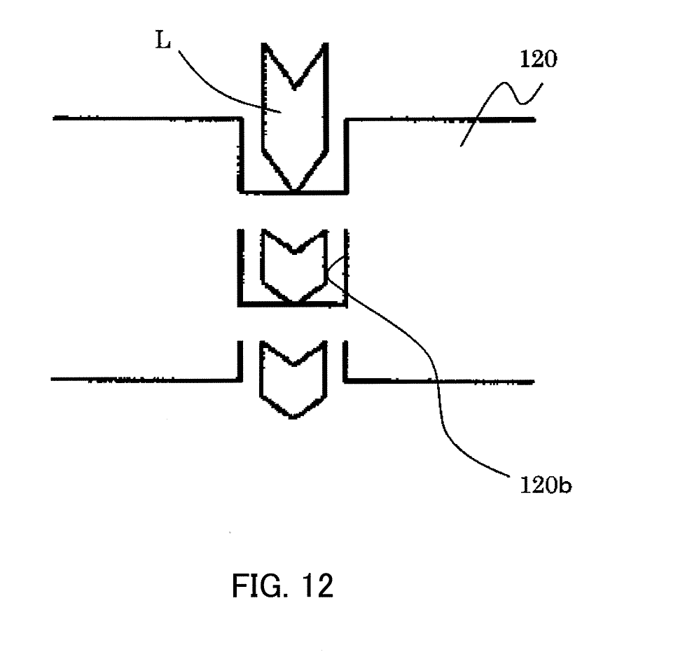

In contrast to this, in the present embodiment, as shown in FIGS. 11 and 12, as compared to the case of FIGS. 13 and 14, the substrate 120 is cut with a small laser output in a plurality of times (that is, stepwise cutting is performed). As a result, as shown in FIG. 11, the width of the cutting groove 120a is reduced as compared to the case shown in FIG. 13, and at the same time, as shown in FIG. 12, the cutting section 120b becomes smoother as compared to the case shown in FIG. 14. Thereby, the quality of the cutting section 120b is improved. Further, as described above, the four corner portions 133a to 133d are cut step by step by a predetermined depth, so that the quality of the cutting section can be improved much more.

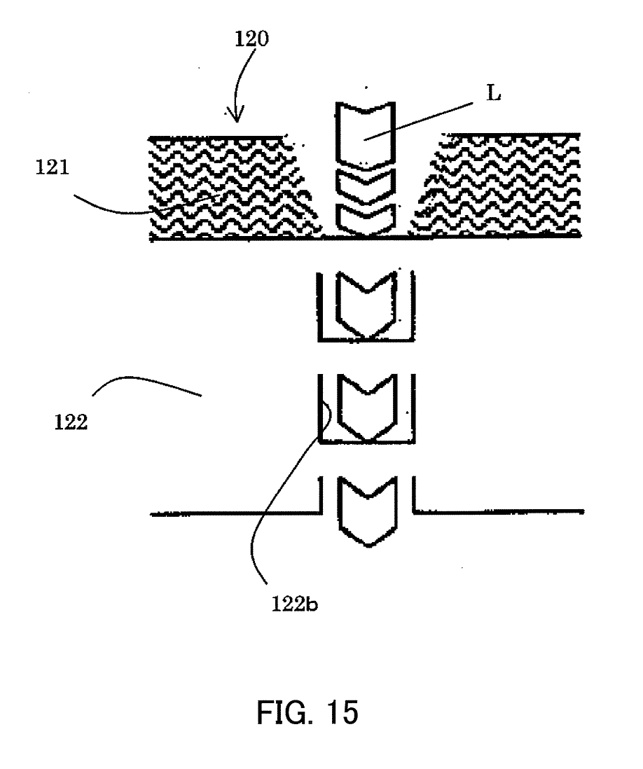

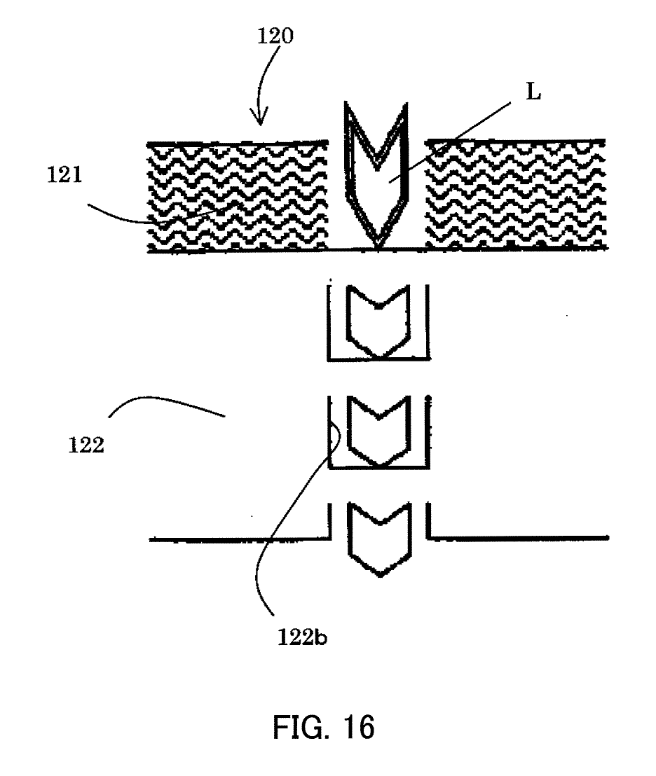

Further, FIGS. 15 and 16 show a more specific stepwise cutting method of the substrate 120 by the laser cutting part 100 of the present embodiment.

In FIGS. 15 and 16, reference numeral 121 denotes a printed board layer (first layer) composed of glass epoxy and the like forming the top layer of the substrate 120. Reference numeral 122 denotes a package resin layer (second layer) formed of resin such as plastic as a bottom layer of the substrate 120.

FIG. 15 shows a state in which parameters such as the output, wavelength, and Q switch frequency of the laser beam L are set constant, and each of the printed board layer 121 and the package resin layer 122 is cut step by step by a predetermined cutting depth in a plurality of times. The parameters in this case are set to ones (for example, Q switch frequency is 40 kHz) suitable for the cutting of the glass epoxy printed board layer 121 which is the top layer.

On the other hand, FIG. 16 shows a state in which, with the output and wavelength of the laser beam L being kept constant and the Q switch frequency being changed for the printed board layer 121 and the package resin layer 122, the printed board layer 121 and the package resin layer 122 are cut step by step by a predetermined depth in a plurality of times. The Q switch frequency is set to 40 kHz in the case where the printed board layer 121 is cut, and to 15 kHz in the case where the package resin layer 122 is cut.

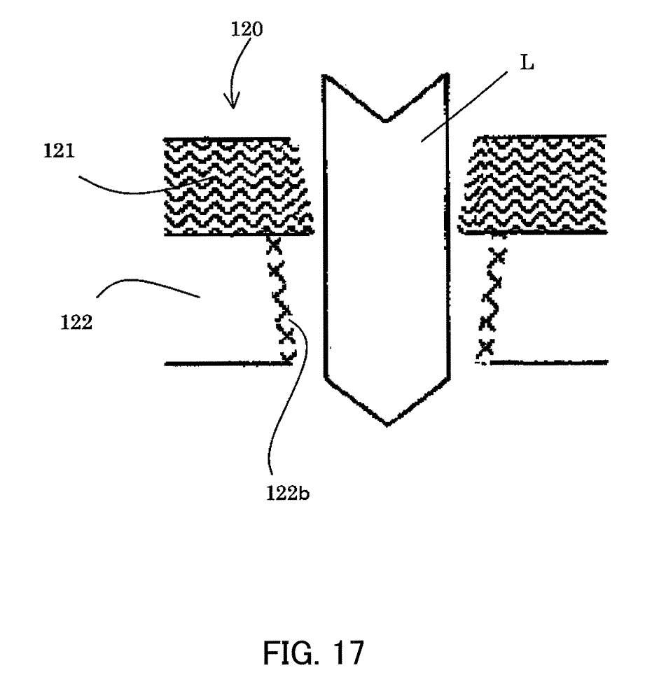

In contrast to this, FIG. 17 shows an example of the case where the substrate 120 is cut by the laser irradiation in a single time. In this case, though the cutting speed is fast as compared to the stepwise cutting, both cutting sections of the printed board layer 121 and the package resin layer 122 become coarse, and particularly the cutting section 122b of the package resin layer 122 may become extremely coarse.

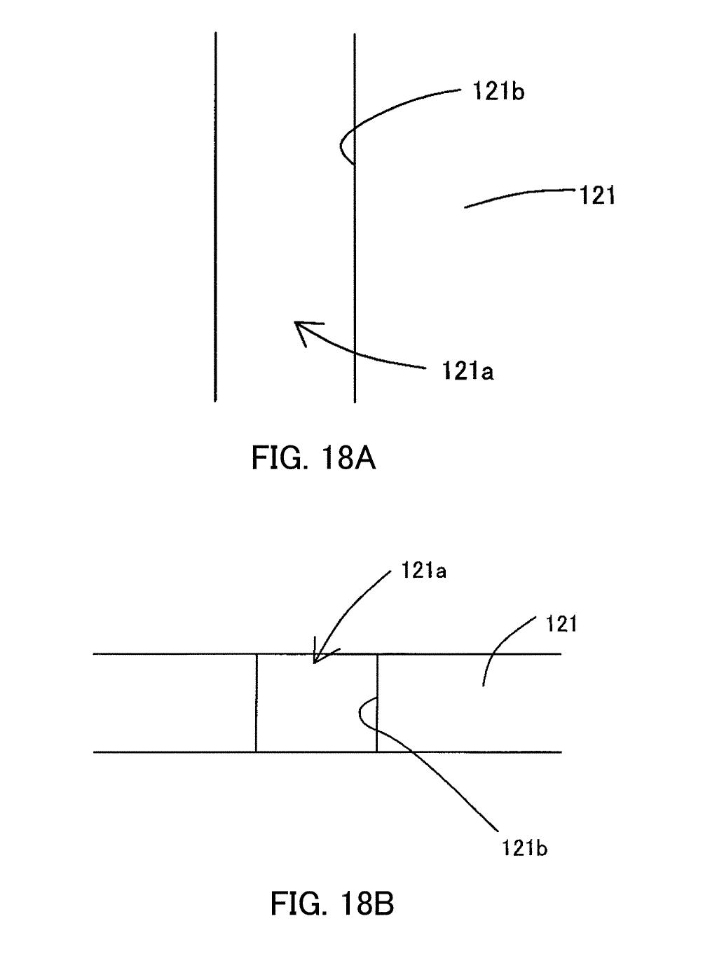

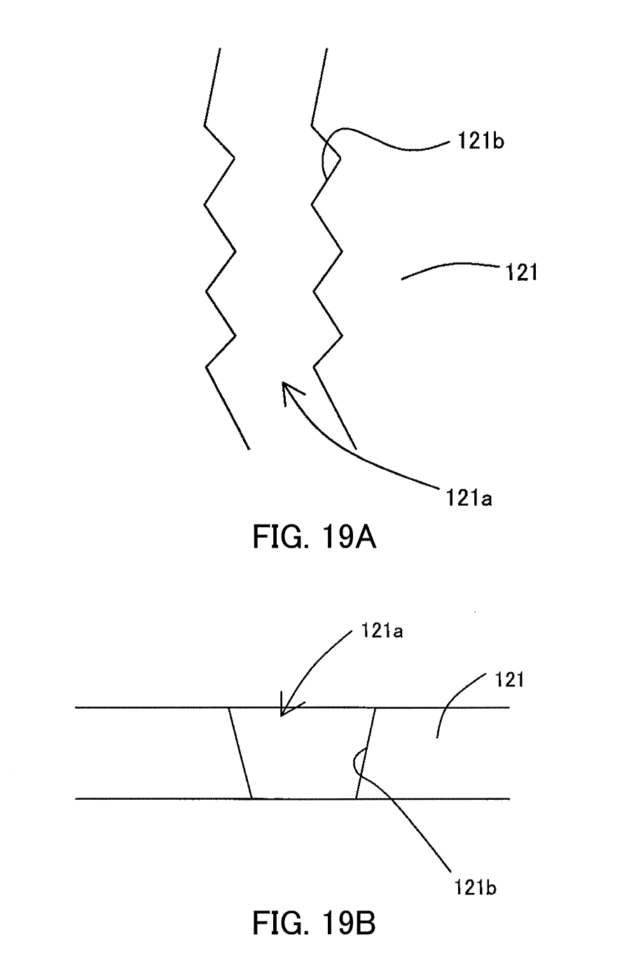

FIGS. 18A and 18B schematically show the experimental result in the case where the printed board layer 121 of 0.2 mm in thickness was cut by the laser irradiation in 10 times at a high frequency (40 kHz) (cutting speed 500 m/s). FIGS. 19A and 19B schematically show the experimental result in the case where the same printed board layer 121 was cut by the laser irradiation in 10 times at a low frequency (15 kHz) (cutting speed 500 m/s). FIGS. 18A and 19A are top plan views, and FIGS. 18B and 19B are sectional views.

When the high frequency was used, the cutting section 121b of the cutting groove 121a formed in the printed board layer 121 was finished smoother as compared to the case where the low frequency was used. Further, when the high frequency was used, the width of the cutting groove 121a became thin as compared to the case where the low frequency was used. However, even when the low frequency was used, by cutting in 10 times a better cutting section and a thin cutting groove were obtained as compared with the case where the cutting was made in a single time as shown in FIG. 17.

As to the package resin layer (thickness 0.7 mm) 122, though not shown, the cutting section was finished smoother in the case where the cutting was performed in 10 times by using the low frequency (15 kHz) as compared to the case where the cutting is performed in 10 times by using the high frequency. Also, the width of the cutting groove became thinner in the case where the low frequency is used as compared to the case where the high frequency is used. In these cases, the cutting speed was 500 m/s.

From this, it was found preferable that the low frequency (first frequency) is 20 used for the package resin layer 122 and the high frequency (second frequency higher than the first frequency) is used for the printed board layer 121. When the package resin layer and the printed board layer were cut in 10 times, respectively, better cutting sections were obtained as compared to the case where they were cut in 25 times.

Hence, it was found preferable that the number of cuttings is close to 10 times or its vicinity.

However, the above described is one of the experimental examples, and embodiments of the present invention are not limited thereto. In reality, depending on the materials of the printed board layer 121 and the package resin layer 122, it is desirable that the parameters such as the Q switch frequency and the output of the laser beam are changed for each layer and the number of steps for cutting (that is, the number of scanning times of laser beam) is changed. In this case, one layer may be cut by the laser beam scanning in a single time. As a result, optimization of the quality of the cutting section and cutting ability (cutting speed and the like) are permitted for each layer.

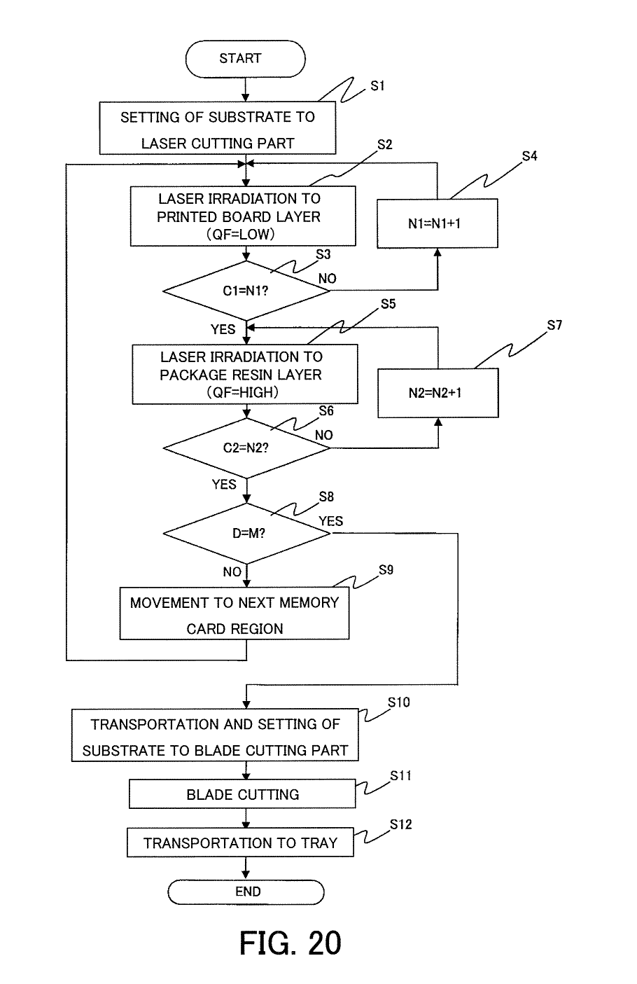

The procedure of the stepwise cutting processing of the substrate 120 as described above will be collectively shown in the flowchart of FIG. 20. The stepwise cutting processing is executed according to the computer program stored in the controllers 150 and 250.

At step (abbreviated as S in the figure) 1, the substrates 120 are transported one by one from the first to second positions I to II in the laser cutting part 100 from the first substrate magazine 102 shown in FIG. 1, and are adsorbed to the movable stage. The movable stage is moved, so that the center of the first memory card region 135 in the substrate 120 is aligned with the laser beam irradiation center position (position on the center axis LO of the laser oscillator 110).

At step 2, the Q switch frequency (QF=High: for example, 40 kHz) suitable for the printed board layer 121 is set, and the predetermined cutting lines 133 (corner portions 133a to 133d) of the printed board layer 121 are irradiated with the laser beam.

Next, at step 3, it is determined whether or not the number of laser irradiation times (counter value) C1 performed at step 2 is N1 (for example, 10 times), and if it is not yet N1, the procedure advances to step 4.

At step 4, the number of laser irradiation times C1 is incremented by 1, and at step 2, the laser beam irradiation is again performed.

Steps 2 to 4 are repeated, and when the number of laser irradiation times C1 reaches N1 at step 3, the procedure advances to step 5.

At step 5, the Q switch frequency (QF=Low: for example, 15 kHz) suitable for the package resin layer 122 is set, and the predetermined cutting lines 133 (corner portions 133a to 133d) of the package resin layer 122 are irradiated with the laser beam.

Next, at step 6, it is determined whether or not the number of laser irradiation times (counter value) C2 performed at step 5 is N2 (for example, five times), and if it is not yet N2, the procedure advances to step 7.

At step 7, the number of laser irradiation times C2 is incremented by 1, and at step 5, the laser irradiation is again performed.

Steps 5 to 7 are repeated, and when the number of irradiation times C2 reaches N2 at step 6, the procedure advances to step 8.

At step 8, it is determined whether or not the number of memory card region (counter value) D having been finished with the laser cutting processing reaches the number M of all memory card region (for example, 12 shown in FIGS. 5 and 6) formed on the substrate 120. If D does not reach M yet, the procedure advances to step 9, and the movable stage is driven so that the center of the next memory card region is aligned with the laser beam irradiation center position. Then, steps 2 to 7 are repeated.

At step 8, when D reaches M, that is, when the laser cutting of the corner portions of all the memory card regions is completed, the procedure advances to step 10.

At step 10, the substrate 120′ is transported to the fifth position V from the third position III through the fourth position IV in the blade cutting part 200. At step 11, the predetermined cutting lines 133 (a plurality of horizontal and vertical straight line portions 131 and 132) of the substrate 120′ are cut.

When the cutting of all the straight line portions 131 and 132 is completed, the procedure advances to step 12, and each memory card 135′ is transported to the sixth to eighth positions VI to VIII, and is finally stored on the storage tray 210.

### Second Embodiment

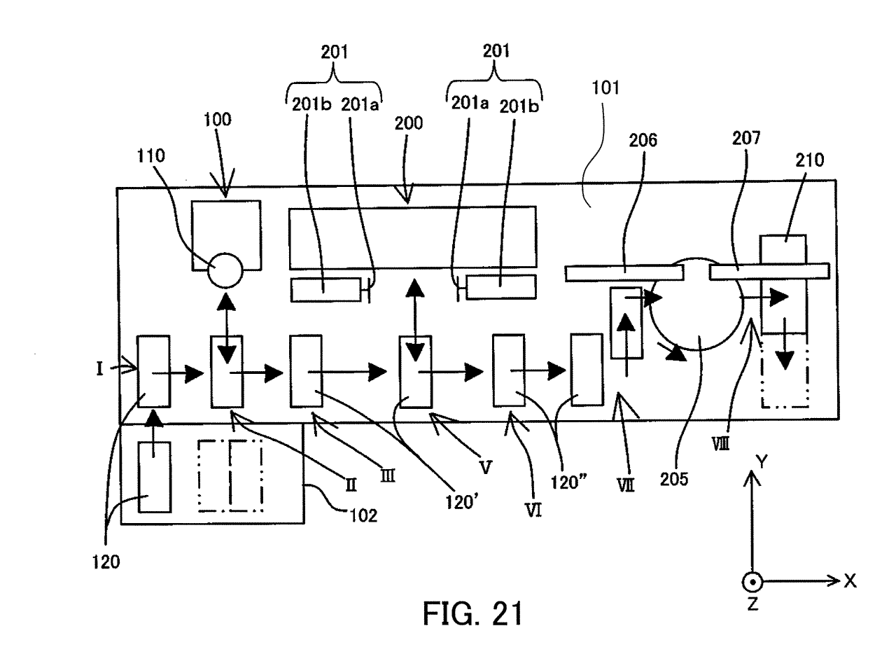

FIG. 21 shows the configuration of a semiconductor cutting system which is a second embodiment of the present invention. The system of the first embodiment (FIG. 1) has been described on the case where the laser cutting part 100 and the blade cutting part 200 are combined into a separate apparatus. However, in the present embodiment, the system is configured to be one apparatus having both of the laser cutting part 100 and the blade cutting part 200.

In FIG. 21, the components common with the first embodiment (FIG. 1) are attached with the same reference numerals as the first embodiment, and this will be substituted for the description thereof.

In the present embodiment, a laser oscillator 10 and two cutting blade units 201 are provided on a base 101.

The method and procedure for cutting a substrate in the present embodiment are the same as the first embodiment.

### Third Embodiment

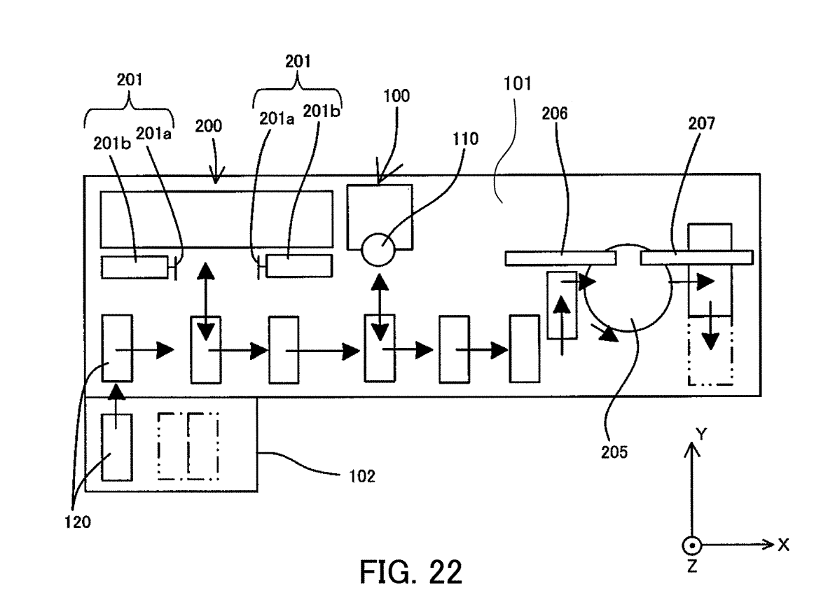

FIG. 22 shows the configuration of a semiconductor cutting system which is a third embodiment of present invention. In the systems shown in the first embodiment (FIG. 1) and the second embodiment (FIG. 21), after the cutting of the corner portions by the laser cutting part 100, the cutting of the straight line portions by the blade cutting part 200 is performed. In contrast to this, in the present embodiment, first, the straight line portions are cut by a blade cutting part 200, and then, the corner portions of the individualized memory card region are cut by a laser cutting part 100.

In FIG. 22, the components common with the first and second embodiments are attached with the same reference numerals as these embodiments, and this will be substituted for the description. Further, in the present embodiment, though a case is shown where the system is configured to be one apparatus provided with two blade cutting units 201 and a laser oscillator 10 on a base 101, similarly to the first embodiment, the blade cutting part 200 and the laser cutting part 100 may be configured as separate apparatus, respectively.

In the present embodiment, steps 10 to 11 shown in FIG. 20 are performed in advance, and after that, steps 1 to 9 are performed.

### Fourth Embodiment

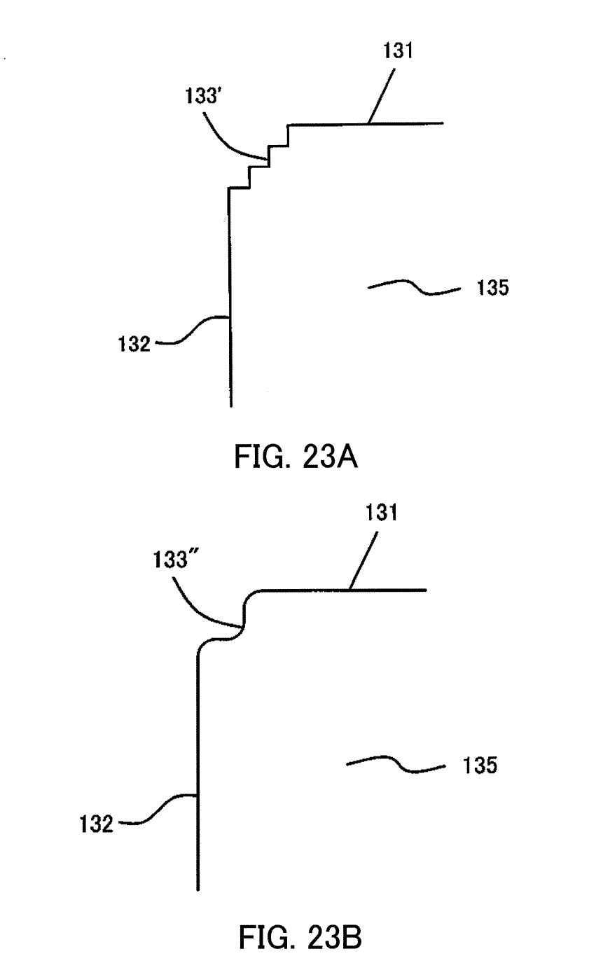

In each of the above described embodiments, though a description has been made on the case where the odd-shaped line portion to be cut by the leaser beam has the shape of a ¼ arc, this odd-shaped line portion may be shaped as shown in FIGS. 23A and 23B.

FIG. 23A shows an odd-shaped line portion 133′ having a stepped shape combining discontinuous straight lines. Further, FIG. 23B shows an odd-shaped line portion 133″ having a shape combining discontinuous straight lines and curves.

A semiconductor cutting system of embodiments of the present invention can be also applied to the cutting of the odd-shaped line portion having a shape other than these shapes.

Further, in each of the above embodiments, a description has been made on the case where individual semiconductor device is cut out by combining the cutting by the cutting blade and the cutting by the laser beam. However, embodiments of the present invention include the case where each semiconductor device is cut out from the semiconductor substrate by the scanning only of the laser beam. In this case, the semiconductor device is cut into chips by performing an orbital scanning of the laser beam in a plurality of times along with an annular (endless) predetermined cutting line shown in FIG. 5. Even in this case, as described in the foregoing embodiments, the quality of the cutting section can be made well and the trouble due to the heat can be avoided. Further, in this case also, it is preferable that the scanning center of the laser beam is positioned above the position (center of the semiconductor device region) inner than the predetermined cutting line of each semiconductor device region and that the parameter and the number of scanning times of the laser beam are changed per each layer of the semiconductor substrate.

According to the first to fourth embodiments, since the scanning center of the laser beam is set above the position inner than the predetermined cutting line of the semiconductor device region such as the center of each semiconductor device region, even when the distance from the semiconductor substrate to the laser scanning center is not increased so much, the inclination of all the cutting sections of each semiconductor device can be made small.

Further, according to the first to fourth embodiments, the second portion such as a curved shape unable to be cut out by the cutting blade can be cut out by using the laser beam, and the first portion having a straight line shape can be cut out by using the cutting blade. Hence, the semiconductor device having the odd-shaped cutting section and the good straight line cutting section can be cut out at a high speed.

Further, according to the first to fourth embodiments, the laser beam is scanned along the same predetermined cutting line in a plurality of times, and the cutting of a shallow depth is repeated so as to cut the semiconductor substrate. Hence, as compared to the case where the cutting is performed in a single time, the output of the laser beam can be reduced, and the quality of the cutting section can be made well. Further, heat value by the laser beam irradiation can be also reduced, and the increase in the cut width and the change in the semiconductor can be avoided. Further, since the cutting depth at a single time is shallow, the scanning speed in a single time can be made at a high speed, and even when the scanning is repeated in a plurality of times, the time required for the cutting can be shortened as a result.

### Fifth Embodiment

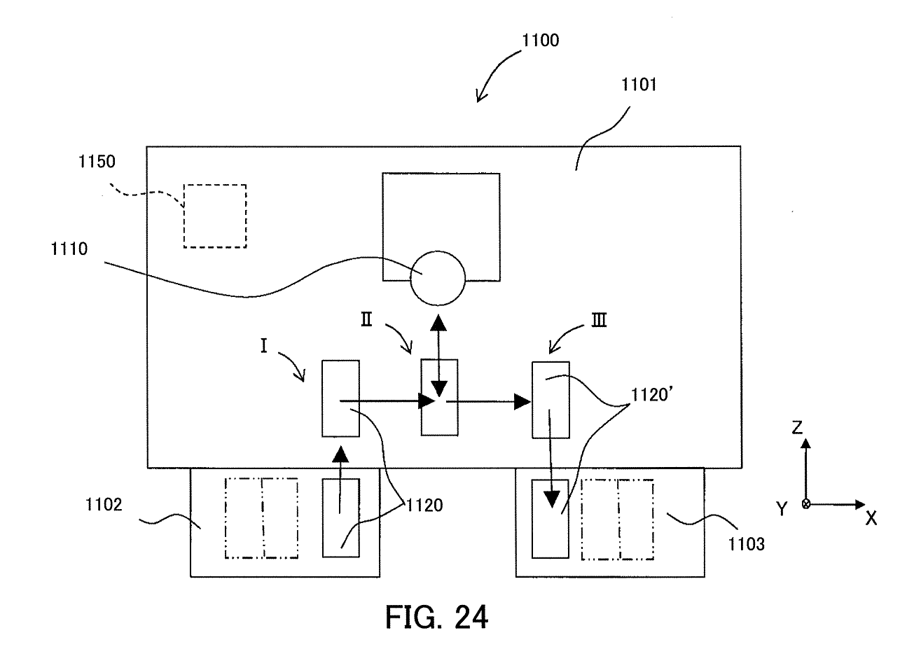

FIG. 24 shows the configuration of a laser cutting apparatus seen from the above, which is a fifth embodiment of the present invention. In FIG. 24, reference numeral 100 denotes the laser cutting apparatus.

The laser cutting apparatus 100 includes a base 101 and a laser oscillator 1100 installed on the base 1101. Reference numeral 1102 denotes a first substrate magazine with large quantities of semiconductor substrates 1120 stored therein before laser cutting processing, and by an unshown first transport mechanism, a semiconductor substrate 1120 is transported to a first position I on the base 1101 from the substrate magazine 1102 one by one.

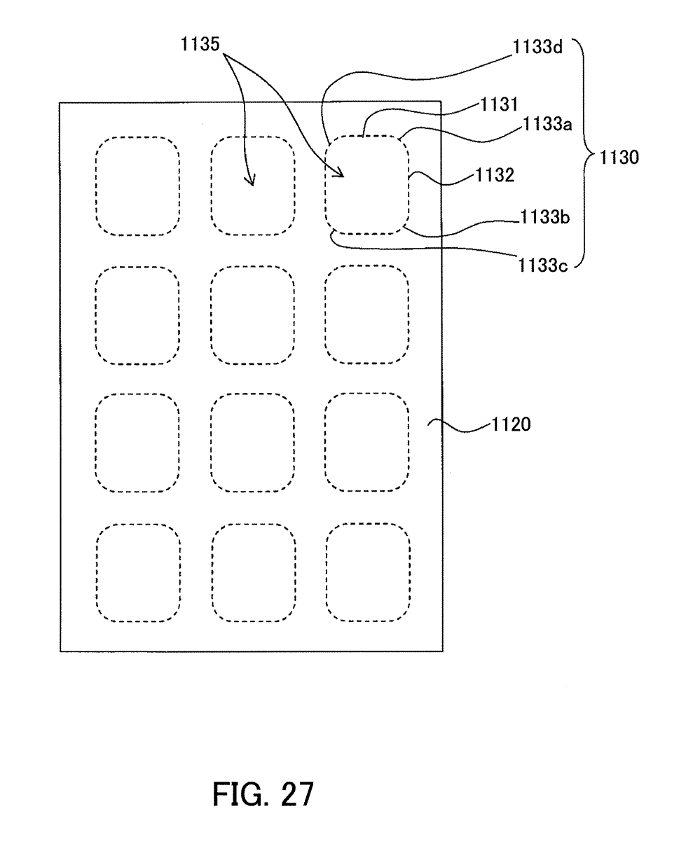

The semiconductor substrate 1120 before the cutting processing is shown in FIG. 27. Here, as one of the semiconductor substrates 1120, the memory card substrate is shown as an example. The memory card substrate 1120 is sealed (coated) by resin on a printed wiring board on which circuits for a plurality of memory cards are formed, after memory chips and controller chips are mounted.

Dotted lines 1130 are predetermined cutting lines of the memory card substrate 1120. The predetermined cutting line 1130 includes a first straight line portion 1131 continuously extending in the horizontal direction in the figure, a second straight line portion 1132 continuously extending in the vertical direction, and four corner portions 1133a to 1133d having a ¼ arc curve shape as an odd-shaped line portion connecting these first and second straight line portions f1131 and 1132. However, the predetermined cutting line 1130 is a virtual line and not actually drawn on the memory card substrate 1120, but stored in the memory inside controller (computer) 1150 provided in the laser cutting apparatus 1100.

Each region 135 surrounded by two straight line portions 1131 and 1132 and four corner portions 1133a to 1133d is a semiconductor device region directly serving as a memory card as the individual semiconductor device by cutting the substrate 1120 along the predetermined cutting line 1130. Hereinafter, each semiconductor device region (predetermined cutting region) before cutting is referred to as a memory card region 1135. As the semiconductor device, it may be a device other than the memory card, for example, a chip element such as IC and LSI.

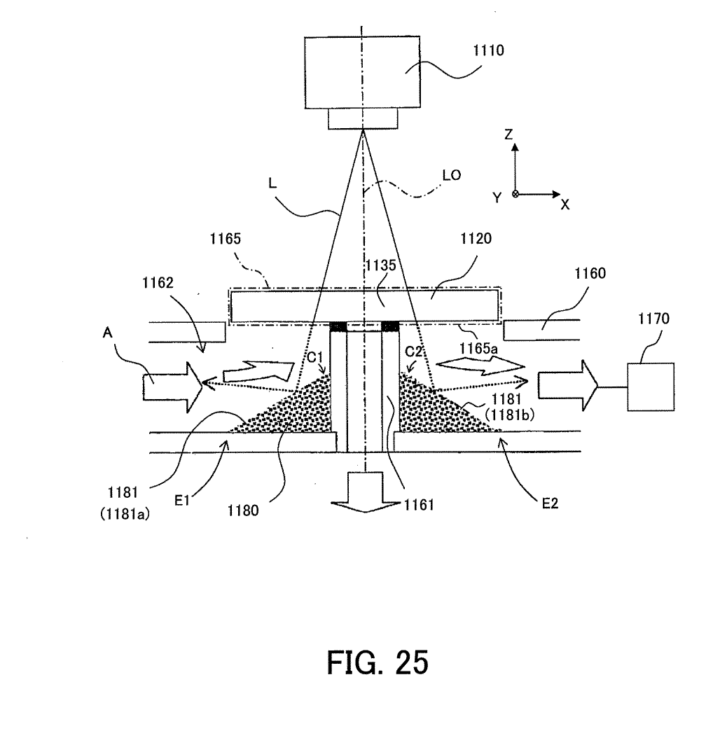

In FIG. 24, the substrate 1120 positioned at the first position I is transported to a second position II which is the front surface of a laser oscillator 1110 by an unshown second transport mechanism. At the second position II, a movable stage to be described later is provided, and the substrate 1120 transported onto the movable stage is fixed thereon with its bottom surface adsorbed by negative pressure. The movable stage, as shown in FIG. 25, is driven such that the center of the memory card region 1135 is positioned on a center axis LO of the laser oscillator 1110.

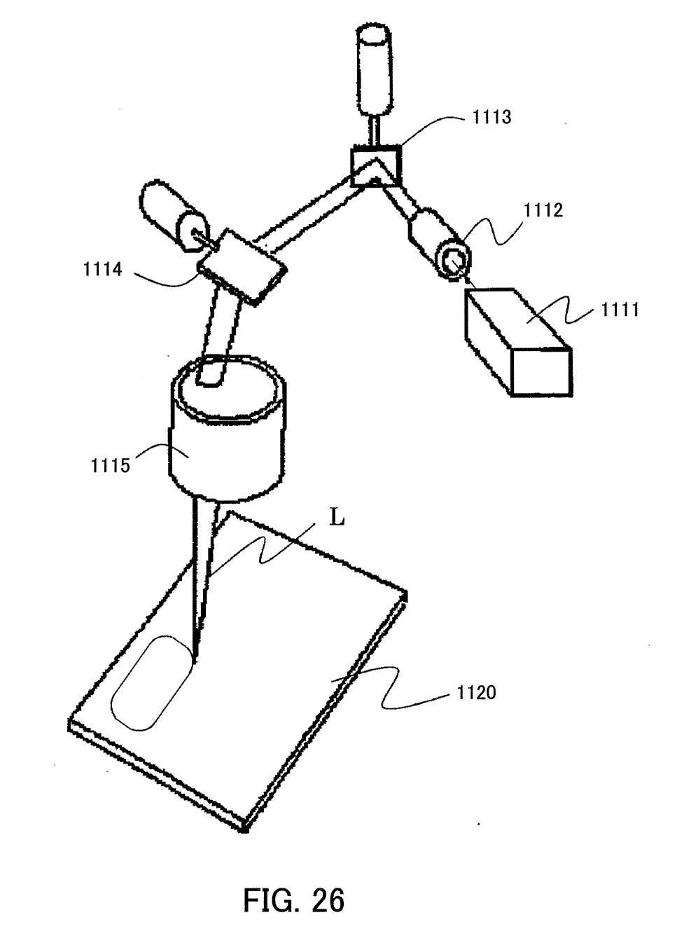

The laser oscillator 1110, for example, is configured as shown in FIG. 26. A laser beam L emitted from a laser light source 1111 is expanded in light beam diameter by a beam expander 1112, and after that, it is sequentially reflected by Y-axis and X-axis galvanomirrors 1113 and 1114 as scanning devices. The laser beam L reflected by the galvanomirrors 1113 and 1114 forms a spot image on the substrate 1120 positioned on a cutting processing position by a condensing optical system 1115 such as an f-θ lens.

The spot image is scanned in the Y-axis direction (vertical direction in FIG. 27) and the X-axis direction (horizontal direction in FIG. 27) according to the rotation of the galvanomirrors 1113 and 1114. Hence, controlling the rotation angles of the galvanomirrors 1113 and 1114 can move the spot image of the laser beam L can be moved along the predetermined cutting line 1130, and as a result, a moving track of the spot image in the substrate 1120 is melted and cut. Thus, the memory card 1135 can be cut out.

That is, in the laser cutting apparatus 1110 of the present embodiment, when the single memory card region 1135 is cut, the laser beam is scanned without moving the substrate 1120 in the X-axis direction and the Y-axis direction.

In the present embodiment, as the laser beam source 1111, a YAG laser (for example, wavelength:1.06 μm) is used. Further, in the present embodiment, when the substrate 1120 with the printed board coated by resin is cut, the pulse irradiation frequency (Q switch frequency), current value, cutting speed and the like of the laser pulse are changed with the wavelength of the laser beam kept constant according to the case where the resin portion (package resin layer to be described later) is cut and the case where the printed board portion (printed board layer to be described later) is cut. Further, in the present embodiment, the laser cutting is performed without putting the substrate 1120 into a gas atmosphere. As a result, the configuration of the laser cutting apparatus 1100 is made simple, and at the same time, different from the laser cutting in the gas atmosphere difficult to perform other than the straight line cutting, the predetermined cutting line 1130 including the odd-shaped line portion such as a curve can be cut by the scanning of the laser beam without moving the substrate 1120.

Further, in the laser cutting apparatus 1100 of the present embodiment, cutting the predetermined cutting line 1130 of the single memory card region 1135 in the substrate 1120 by a small predetermined amount, that is, repeating the orbiting scanning of the laser beam in a plurality of times can completely cut out the memory card region 1135.

In FIG. 24, the semiconductor substrate 1120′ in which the cutting of all the memory card regions 1135 is completed is taken out to a third position III on the base 1101 from the second position II (movable stage) by an unshown third transport mechanism. The substrate 1120′ is actually a plurality of memory cards cut into chips by the laser cutting. In this third position III, the processing debris such as soot and dust adhered on the substrate 1120′ due to the laser cutting processing is removed by an unshown cleaning mechanism. The cleaned substrate 1120′ is then stored into a second substrate magazine 1103 from the third position III by an unshown fourth transport mechanism.

In FIG. 25, reference numeral 1160 denotes the above described movable stage. The movable stage 1160 is provided with an adsorption head (support member) 1161 to adsorb the bottom surface of the substrate 1120 (memory card region 1135) by negative pressure.

Further, reference numeral 1165 denotes a workpiece setting region in which the substrate 1120 is positioned and installed by being adsorbed by the adsorption head 1161. The under surface (workpiece setting reference surface) 1165a of the workpiece setting region 1165 and the upper and under surfaces of the substrate 1120 disposed in the workpiece setting region 1165 are orthogonal to the center axis (scanning center axis) LO of the laser oscillator 1110.

Inside the movable stage 1160, the flow path 1162 for a dust collection air A is formed so as to extend in the x-direction. The flow path 1162 is connected with a dust collection pump 1170, and sucking force of the dust collection pump 1170 generates a flow of the dust collection air A inside the flow path 1162.

When the laser beam L is irradiated on the substrate 1120 from the laser oscillator 1110 as shown in the figure so as to cut the same, soot and dust arise from the substrate 1120. The dust collection air A has a role of preventing these soot and dust from adhering to the substrate 1120 and a laser receiving member 1180, which will be described later, and collecting them on a filter attached to the dust collection pump 1170.

The laser receiving member 1180 is provided below the workpiece setting region 1165 inside the flow path 1162 so as to have the similar area to that of the workpiece setting area 1165. However, in the present embodiment, since the adsorption head 1161 is provided on the scanning center axis LO of the laser oscillator 1110, the laser receiving member 1180 is provided so as to surround the adsorption head 1161 on an XY plane.

The laser receiving member 1180 is preferably made of the material excellent in heat resistance (fire resistance) and heat-dissipation performance such as aluminum and ceramics.

The top surface (front surface) of the laser receiving member 1180 is a laser receiving surface 1181 which receives the laser beam L having cut and passed through the substrate 1120 installed on the workpiece setting region 1165.

The laser receiving surface 1181 is inclined so as to continuously approach the workpiece setting region 1165 from the outside portions E1 and E2 toward inside, that is, toward the center side portions C1 and C2, that is, so as to extend obliquely upward. The portions C1 and C2 are the portions along the side face of the adsorption head 1161.

In other words, the laser receiving surface 1181 is inclined so as to continuously approach the workpiece setting region 1165 as approaching the scanning center axis LO of the laser beam and the adsorption head 1161.

On the other hand, in FIG. 25, in the left side portion (hereinafter, referred to as an upstream side laser receiving surface) 1181a from the adsorption head 1161 within the laser receiving surfaces 1181, the upstream side laser receiving surface 1181a is inclined so as to gradually approach the workpiece setting region 1165 from the upstream side to the downstream side of the flow path 1162 (that is, a flow of the dust collection air A). In contrast to this, the right side portion (herein after, referred to as a downstream side laser receiving surface) 1181b from the adsorption head 1161 within the laser receiving surfaces 1181 is inclined so as to gradually distance from the workpiece setting region 1165 from the upstream side to the down stream side, that is, it is inclined so as to extend obliquely downward.

What is meant by describing that the laser receiving surface 1181 is inclined so as to approach or distance from the workpiece setting region 1165 can be restated that the laser receiving surface 1181 is inclined to or is not parallel to the workpiece setting region 1165a.

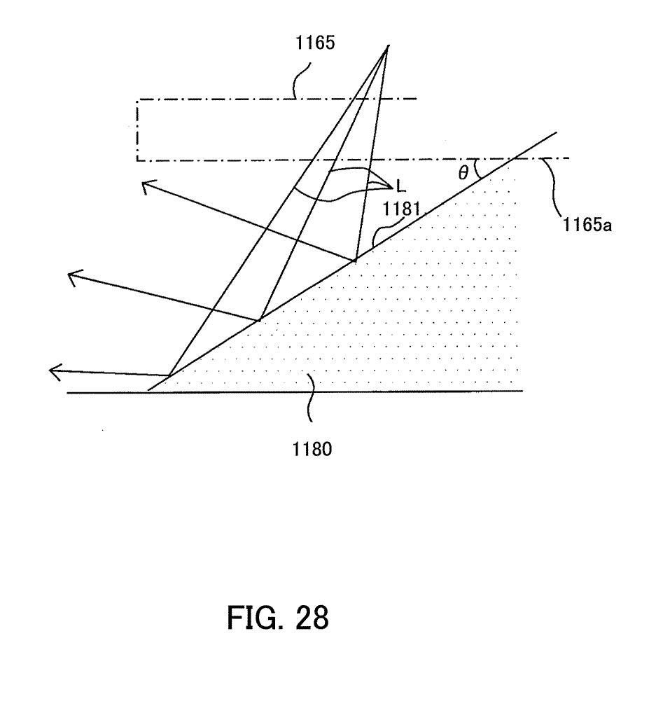

The laser beam L passed through the substrate 1120 (workpiece setting region 1165) and impinged on the laser receiving surface 1181 is reflected in directions different from the workpiece setting region 1165 because the laser receiving surface 1181 is inclined as shown in FIG. 28 in spite of the scanning position, that is, the incident angle on the laser receiving surface 1181. In other words, it is desirable that the inclination angle θ of the laser receiving surface 1181 for the workpiece setting reference region 1165a is set so that the laser beam L reflected at the laser receiving surface 1181 is not directed to the workpiece setting region 1165.

The inclined laser receiving surface 1181 may be provided with a shape allowing the laser beam to be scatteringly reflected such as a matt shape and a shape of alternating ridges and valleys. In this case, observing microscopically, though a surface having a scattering shape does not continuously approach or distance from the workpiece setting region 1165, the laser receiving surface 1181 as a base surface of the surface having the scattering shape continuously approaches or distances from the workpiece setting region 1165. In the present embodiment, including such a case, it is defined that the laser receiving surface continuously approaches (or distances from) the workpiece setting region.

Further, in the laser receiving surface 1181 of the present embodiment, center side portions C1 and C2 are closest to the workpiece setting region 1165, and the external side portions E1 and E2 are most away from the workpiece setting region 1165. In contrast to this, the laser receiving surface may be formed as a one-way inclined surface continuously inclined from one end side to the other end side such that, for example, the one external side portion E1 is most away from the workpiece setting region 1165 and the other external side portion E2 is closest to the workpiece setting region 1165.

However, in this case, a height as a whole of the laser receiving member is increased, thereby increasing the thickness of the movable stage 1160 and enlarging the sectional area of the flow path 1162 accordingly. Thus, the flow rate of the dust collection air A is reduced. Consequently, it is desirable that the laser receiving surface 1181 is formed closest to the workpiece setting region 1165 in the center side portions C1 and C2, and is formed most away from the workpiece setting region 1165 in external side portions E1 and E2. However, embodiments of the present invention include the case also where the laser receiving surface is regarded as an one-way inclined surface.

Further, in the present embodiment, the upstream side laser receiving surface 1181a is inclined so as to continuously approach the workpiece setting region 1165 from the upstream side to the downstream side of the flow path 1162. As a result, the sectional area of the flow path 1162 becomes gradually smaller from the position of the external portion E1 to the position of the center side portion C1 of the upstream side laser receiving surface 1181a. Hence, the flow rate of the dust collection air A flowing therein is increased toward the center side portion C1. Furthermore, a flow of the dust collection air A adjacent to the substrate is deflected to the substrate 1120 side by a guide function of the upstream side laser receiving surface 1181a. Consequently, dust collection performance can be improved without changing sucking ability of the dust collection pump 1170.

Further, the increase of the flow rate of the dust collection air A flowing along the laser receiving surface 1181 can efficiently cool the laser receiving member 1180.

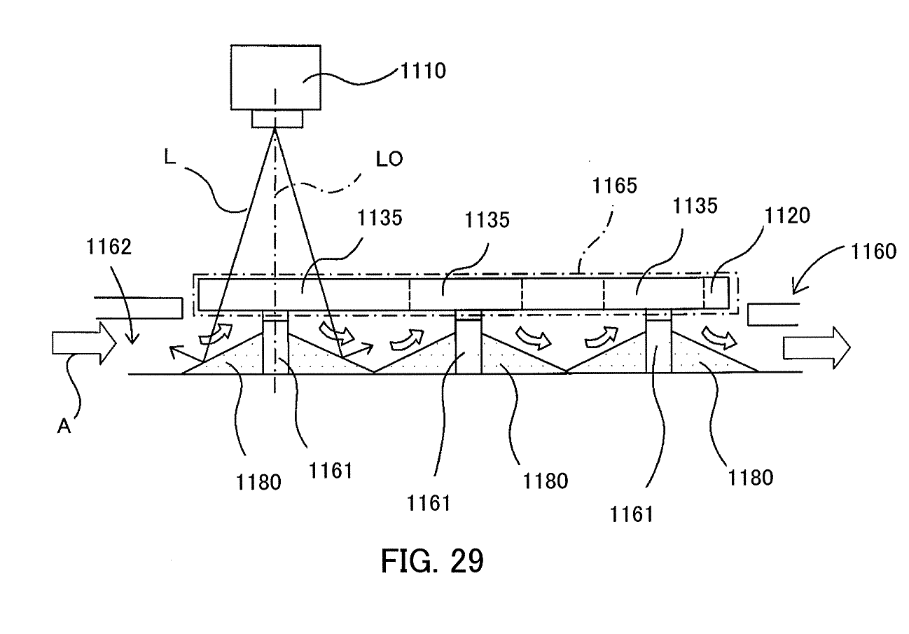

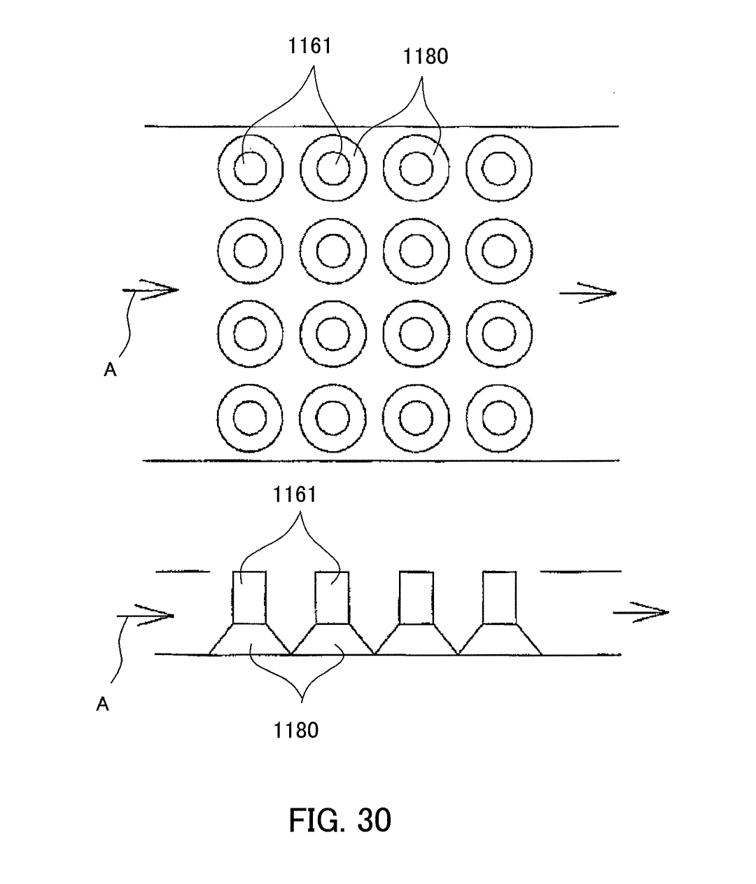

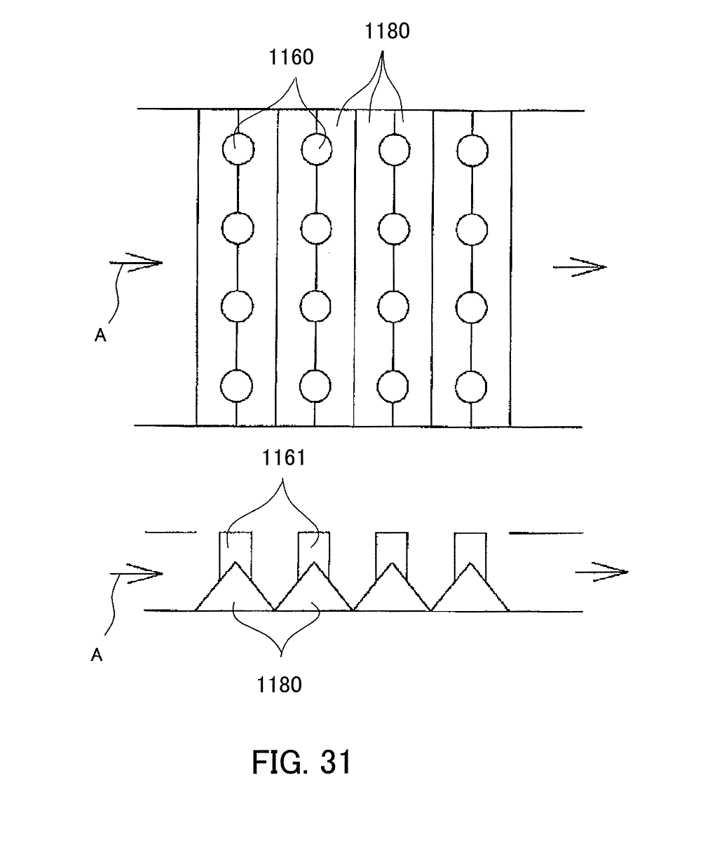

In the present embodiment, as described by using FIG. 27, since the substrate 1120 is formed with a plurality of memory card regions 1135, the configuration of the actual movable stage 1160 is as shown in FIG. 29. That is, the movable stage 1160 is provided with a plurality of adsorption heads 1161 at predetermined intervals, and the periphery of each adsorption head 1161 is provided with the laser receiving member 1180 having the laser receiving surface. In this case, as shown in FIG. 30, the laser receiving member 1180 may be provided for every memory card region 1135 (adsorption head 1161), or as shown in FIG. 31, the laser receiving member 1180 may be provided for every plurality of memory card region 1135 (adsorption heads 1161).

The figures of the upper sides of FIGS. 30 and 31 are the top views, and the figures of the lower sides are the side views. In FIG. 30, the laser receiving member 1180 having a shape of circular truncated cone with the adsorption head 1161 taken as a center is provided for each adsorption head 1161. Further, in FIG. 31, for each adsorption head column composed by a plurality of adsorption heads 1161, the laser receiving member 1180 having a mountain-like section when viewed from the side and extending in the direction to the adsorption head column is provided.

### Sixth Embodiment

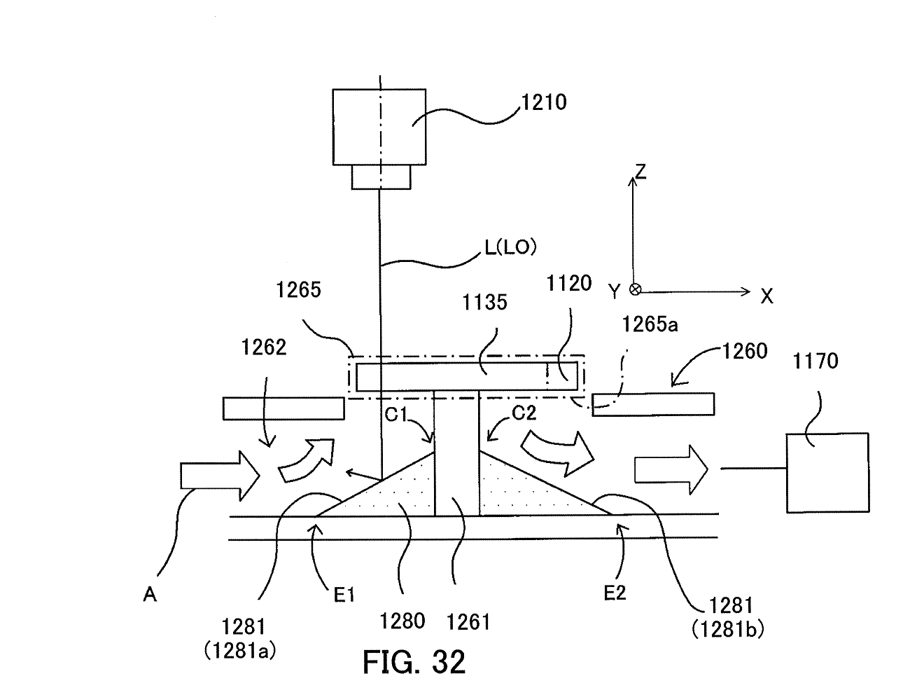

FIG. 32 shows the configuration of a laser cutting apparatus which is a sixth embodiment of the present invention. In the fifth embodiment, though a description has been made on the case where a type of the laser oscillator capable of scanning the laser beam is used as the laser oscillator, in the present embodiment, a description will be made on an apparatus in which a type of the laser oscillator emitting a laser beam in a fixed direction only is used, and driving a movable stage installed with a semiconductor substrate in an XY direction enables to cut the substrate along predetermined cutting lines.

In FIG. 32, reference numeral 1260 denotes a movable stage. The movable stage 1260 is provided with an adsorption head 1261 which adsorbs the bottom surface of a memory card region 1135 in a substrate 1120 by negative pressure.

Further, reference numeral 1265 denotes a workpiece setting region in which the substrate 1120 is installed by being adsorbed by the adsorption head 1261. A workpiece setting reference surface 1265a which is the bottom surface of the workpiece setting region 1265 and the top and bottom surfaces of the substrate 1120 disposed in the workpiece setting region 1265 are orthogonal to the center axis LO of the laser oscillator 1210.

The laser oscillator 1210 includes an unshown laser beam source and a condensing optical system which condenses the laser beam emitted from the laser beam source in the direction (exactly downward direction) along the center axis LO.

Inside of the movable stage 1260, a flow path 1262 for a dust collection air A is formed so as to extend in the X direction. The flow path 1262 is connected with a dust collection pump 1170, and sucking force of the dust collection pump 1170 generates a flow of the dust collection air A inside the flow path 1262.

Reference numeral 1280 denotes a laser receiving member, which is provided in such as manner to have a similar area to that of the workpiece setting region 1265 below the workpiece setting region 1265 inside the flow path 1262.

The laser receiving member 1280 is preferably made of the material excellent in heat resistance (fire resistance) and heat dissipation performance such as aluminum and ceramics.

The top surface (front surface) of the laser receiving member 1280 is a laser receiving surface 1281 receiving a laser beam L which has cut out and passed through the substrate 1120 disposed in the workpiece setting region 1265.

The laser receiving surface 1281 is inclined so as to continuously approach the workpiece setting region 1265 from the external side portions E1 and E2 to the center side portions C1 and C2. Further, the laser receiving surface 1281 is inclined so as to continuously come closer to the workpiece setting region 1265 as approaching the adsorption head 1261.

Further, of the laser receiving surfaces 1281, the upstream side laser receiving surface 1281a is inclined so as to continuously approach the workpiece setting region 1265 from the upstream side to the downstream side of the flow path 1262. In contrast to this, the downstream side laser receiving surface 1281b of the laser receiving surfaces 1281 is inclined so as to continuously distance from the workpiece setting region 1265 from the upstream side to the downstream side of the flow path 1262.

What is meant by describing that the laser receiving surface 1281 is inclined so as to approach or distance from the workpiece setting region 1265 can be also restated that the laser receiving surface 1281 is inclined to or not in parallel.

The laser beam L (each beam) impinging on the laser receiving surface 1281 is reflected in directions different from the workpiece setting region 1265 because the laser receiving surface 1281 is inclined. In other words, it is desirable that the angle of inclination of the laser receiving surface 1281 to the workpiece setting reference surface 1265a is set so that the laser beam L reflected on the laser receiving surface 1281 is not directed to the workpiece setting region 1265.

In the present embodiment also, the inclined laser receiving surface 1281 may be provided with a shape allowing the laser beam to be scatteringly reflected such as a matt shape and a shape of alternating ridges and valleys. In this case, it may be conceivable that the laser receiving surface 1281 as a base surface of the surface having a scattering shape continuously approaches (or distances from) the workpiece setting region 1265.

Further, the laser receiving surface 1281 of the present embodiment is closet to the workpiece setting region 1265 in center side portions C1 and C2, and most distanced from the workpiece setting region 1265 in the external side portions E1 and E2. However, for example, the laser receiving surface may be formed as a one-way inclined surface such that the external portion E1 is most distanced from the workpiece setting region 1265 and the external portion E2 is closest to the workpiece setting region 1265.

Further, in the present embodiment also, the upstream side laser receiving surface 1281a is inclined so as to continuously approach the workpiece setting region 1165 from the upstream side to the downstream side of the flow path 1262. As a result, the sectional area of the flow path 1262 becomes gradually smaller across from the external side portion E1 to the center side portion C of the upstream side laser receiving surface 1281a. Hence, the flow rate of the dust collection air A flowing therein increases toward the center side portion C. Furthermore, a flow of the dust collection air A in the vicinity of the substrate 1120 is deflected to the substrate side by the guide function of the upstream side laser receiving surface 1281a. Consequently, the dust collection performance can be improved without changing the sucking ability of the dust collection pump 1170.

In each of the above described embodiments, though a description has been made on the case where the laser receiving surface of the laser receiving member is taken as an inclined surface (planar surface), the laser receiving surface may be formed as a curved surface such as a concave surface.

According to the fifth and sixth embodiments, as described above, the laser receiving surface simply constructed as an inclined surface and the like to approach the workpiece setting region (that is, workpiece) is used, so that damages of the workpiece by the laser beam reflected by the laser receiving member can be effectively avoided.

Further, the laser receiving member disposed inside the flow path for the dust collection air is provided with the laser receiving surface which approaches the workpiece setting region from the upstream side to the downstream side of the dust collection air, so that the flow rate of the dust collection air flowing along the laser receiving surface can be increased or the direction of a flow of the dust collection air can be deflected to the workpiece setting region side. As a result, the removal function of the soot and dust due to the dust collection air can be improved.

### Seventh Embodiment

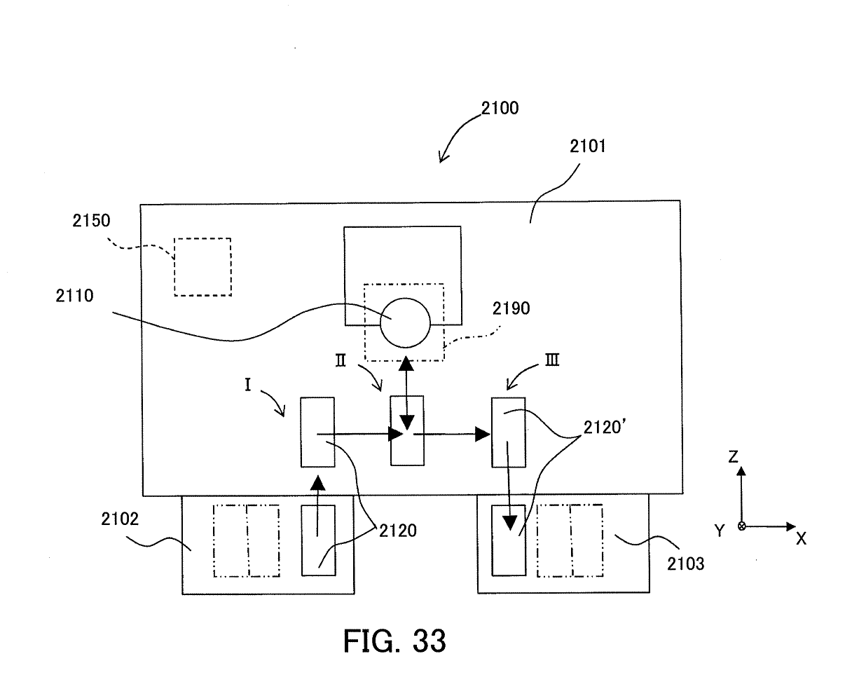

FIG. 33 shows the configuration of a laser cutting apparatus seen from above, which is a seventh embodiment of the present invention. In FIG. 33, reference numeral 2100 denotes a laser cutting apparatus.

The laser cutting apparatus 2100 includes a base 2101 and a laser oscillator 2100 installed on the base 2101. Reference numeral 2102 denotes a first substrate magazine stored with large quantities of semiconductor substrates 2120 before cutting processing, and by an unshown first transport mechanism, a semiconductor substrate 2120 is transported to a first position I on the base 2101 from the first substrate magazine 2102 one by one.

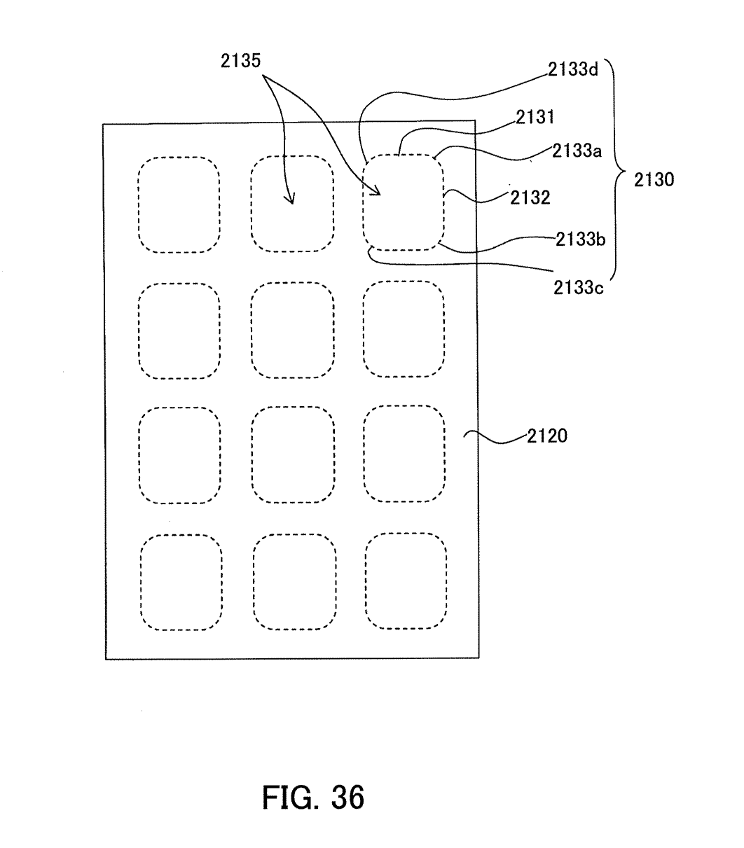

The semiconductor substrate 2120 before the cutting processing is shown in FIG. 36. Here, as one of the semiconductor substrates 2120, a memory card substrate 2120 is shown as an example. The memory card substrate 2120 is sealed (coated) by resin on a printed wiring board with circuits for a plurality of memory cards formed after memory chips and controller chips are mounted.

Dotted lines 2130 are predetermined cutting lines of the memory card substrate 2120. The predetermined cutting line 2130 includes a first straight line portion 2131 continuously extending in the horizontal direction in the figure, a second straight line portion 2132 continuously extending in the vertical direction, and four corner portions 2133a to 2133d having a ¼ arc curve shape as an odd-shaped line portion connecting these first and second straight line portions 2131 and 2132. However, the predetermined cutting line 2130 is a virtual line and not actually drawn on the memory card substrate 2120, but stored in the memory inside controller (computer) 2150 provided in the laser cutting apparatus 2100.

Every single region 2135 surrounded by two pieces each of the straight line portions 2131 and 2132 and four corner portions 2133a to 2133d is a semiconductor device region directly serving as a memory card as the individual semiconductor device by cutting the substrate 2120 along the predetermined cutting line 2130. Hereinafter, each semiconductor device region (predetermined cutting region) before cutting is referred to as a memory card region 2135. As the semiconductor device, it may be a chip element and the like such as IC and LSI other than the memory card.

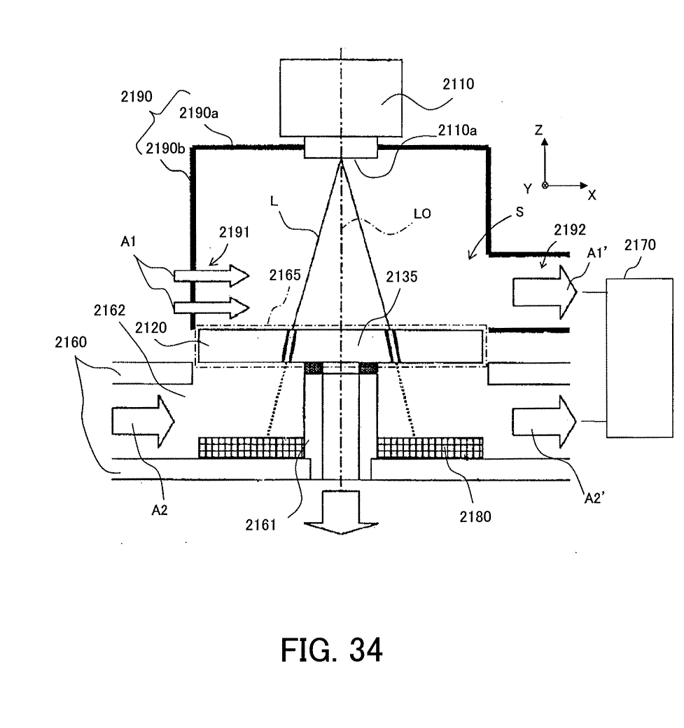

In FIG. 33, the substrate 2120 disposed at a first position I is transported to a second position II which is the front surface of a laser oscillator 2110 by an unshown second transport mechanism. At the second position II, a movable stage to be described later is provided, and the substrate 2120 transported onto the movable stage is fixed on the movable stage with its bottom surface being adsorbed by negative pressure. The substrate 2120 fixed on the movable stage, as shown in FIG. 34, is moved to a laser beam irradiation position by driving the movable stage so that the center of the memory card region 2135 is positioned on the center axis LO of the laser oscillator 2110.

Further, the substrate 2120 moved to the laser beam irradiation position is disposed inside a space surrounded by a cover member 2190. With respect to the cover member 2190, a description will be made later.

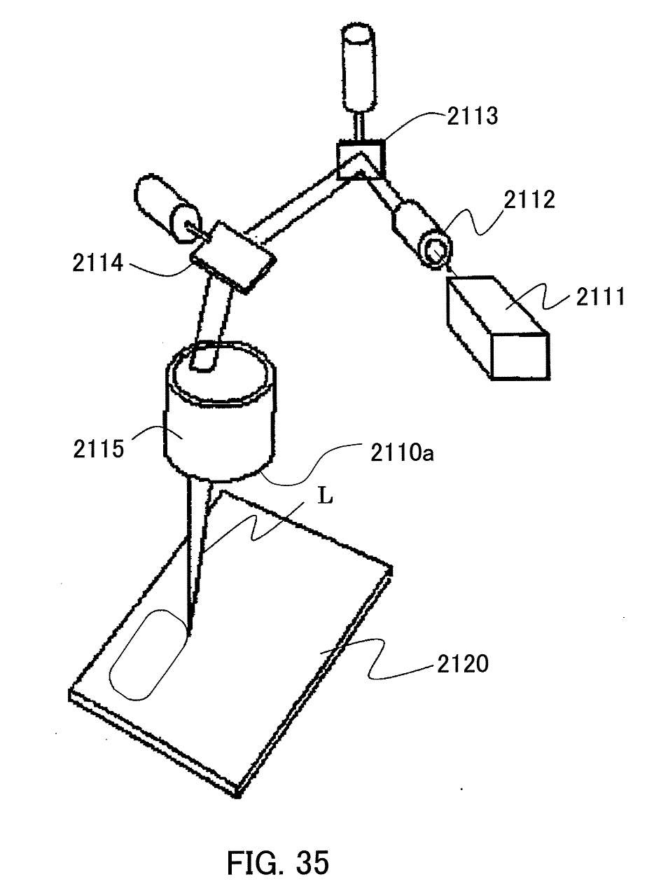

The laser oscillator 2110, for example, is configured as shown in FIG. 35. A laser beam L emitted from a laser beam source 2111 is expanded in light beam diameter by a beam expander 2112, and after that, is sequentially reflected by the galvanomirrors 2113 and 2114 for Y-axis and X-axis as scanning devices. The laser beam L reflected by the galvanomirrors 2113 and 2114 forms a spot-image on the substrate 2120 disposed at a cutting processing position by a condensing optical system 2115 such as an f-θ lens.

The spot image is scanned in the Y-axis direction (vertical direction in FIG. 36) and the X-axis direction (horizontal direction in FIG. 36) according to the rotation of the galvanomirrors 2113 and 2114. Hence, controlling the rotation angles of the galvanomirrors 2113 and 2114 can move the spot image of the laser beam L along the predetermined cutting line 2130, and as a result, a moving track of the spot image in the substrate 2120 is vaporized and melt so as to be cut. Thus, the memory card 2135 can be cut out.

That is, in the laser cutting apparatus 2100 of the present embodiment, when the single memory card region 2135 is cut, the laser beam L is scanned without moving the substrate 2120 in the X axis direction and the Y-axis direction.

In the present embodiment, as a laser beam source 2111, a YAG laser (for example, wavelength:1.06 μm) is used. Further, in the present embodiment, when the substrate 2120 with a printed board coated by resin is cut, the pulse irradiation frequency (Q switch frequency), current value, cutting velocity and the like of the laser beam are changed with the wavelength of the laser beam kept constant according to the case where the resin portion is cut and the case where the printed board portion is cut. Further, in the present embodiment, the laser cutting is performed without putting the substrate 2120 into a gas atmosphere. As a result, the configuration of the laser cutting part 2100 is made simple, and at the same time, different from the laser cutting in the gas atmosphere difficult to perform other than the straight line cutting, the predetermined cutting line 2130 including the odd-shaped line portion such as a curve can be cut by the scanning of the laser beam without moving the substrate 2120.

Further, in the laser cutting apparatus 2100 of the present embodiment, the cutting of a predetermined amount (small amount) for the predetermined cutting line 2130 of a single memory card region 2135 in the substrate 2120, that is, the rotational scanning of the laser beam is repeated in a plurality of times, so that the memory card region 2135 is completely cut.

In FIG. 33, the semiconductor substrate 2120′ in which the cutting of all the memory card regions 2135 is completed is taken out to a third position III on the base 2101 from the second position II (movable stage) by an unshown third transport mechanism. The substrate 2120′ is, in reality, a plurality of memory cards cut into chips by the laser cutting.

At this third position III, the processing debris such as soot and dust adhered on the substrate 2120′ due to the laser cutting processing is removed by an unshown cleaning mechanism. However, the cleaning here is a process performed for sure to completely remove the debris since there is a possibility that the processing debris not having been sufficiently removed by the dust collection air (to be described later) may be left remain on the substrate 2120′.

The substrate 2120′ which was cleaned is stored into the second substrate magazine 2103 from the third position III by an unshown fourth transport mechanism.

In FIG. 34, reference numeral 2160 denotes the aforementioned movable stage, and the movable stage 2160 is provided with an adsorption head (support member) 2161 which adsorbs the bottom surface of the substrate 2120 (memory card region 2135) by negative pressure.

Further, reference numeral 2165 denotes a workpiece setting region in which the substrate 2120 is positioned and installed by being adsorbed by the adsorption head 2161. The top and bottom surfaces of the workpiece setting region and the top surface (front surface) and the bottom surface (rear surface) of the substrate 2120 disposed in the workpiece setting region 2165 are orthogonal to the center axis (scanning center axis) LO of the laser oscillator 2110.

Inside the movable stage 2160, that is, opposite to the laser irradiation space S with respect to the workpiece setting region 2165, a flow path 2162 for a dust collection air A2 (second air) is formed so as to extend in the left and right directions (X direction). In the present embodiment, the movable stage 2160 itself has a role as a flow path forming member to form the flow path 2162.

The flow path 2162 is connected with a dust collection pump 2170, and sucking force of the dust collection pump 2170 generates a flow of the dust collection air A inside the flow path 2162.

As shown in the figure, when the laser beam L is irradiated on the substrate 2120 from the laser oscillator 2110 so as to cut the same, the processing debris such as soot and dust arises from the front surface and the rear surface of the substrate 2120. The dust collection air A2 has a role of preventing the processing debris arisen particularly on the rear surface of the substrate 2120 from adhering to the rear surface of the substrate 2120 and a laser receiving member 2180 to be described later, and collecting them on a filter attached to the dust collection pump 2170. A2′ in FIG. 34 denotes a dust collection an A2 including the processing debris generated at the bottom surface side of the substrate 2120, and being sucked by the dust collection pump 2170.

The laser receiving member 2180 is provided below the workpiece setting region 2165 inside the flow path 2162 so as to have a similar area to that of the workpiece setting region 2165. The laser receiving member 2180 is a member for receiving the laser beam L having cut and passed through the substrate 2120 disposed in the workpiece setting region 2165 and preventing damages of the movable stage 2160 by the laser beam. In the present embodiment, since the adsorption head 2161 is provided on the scanning center axis LO of the laser oscillator 2110, the laser receiving member 2180 is provided on an XY plane so as to surround the adsorption head 2161.

The laser receiving member 2180 is preferably made of the material excellent in heat resistance (fire resistance) and heat-dissipation performance such as aluminum and ceramics.

Further, the cover member 2190 is formed so as to surround a laser irradiation space S which is a space between a laser emission surface 2110a (for example, equivalent to the final lens surface of the condensing optical system 2115 shown in FIG. 35) from which the laser beam is emitted in the laser oscillator 2110 and the workpiece setting region 2165. In other words, the laser irradiation space S covered by the cover member 2190 is a space facing the laser emission surface 2110a of the laser oscillator 2110 and the workpiece setting region 2165. Specifically, the cover member 2190 has an opening which allows the laser emission surface 2110a to be exposed into the laser irradiation space S, and includes an top surface 2190a provided above the workpiece setting region 2165 and a side surface 2190b surrounding the front, back, right and left of the laser irradiation space S.

Though being different from the present embodiment, the cover member 2190 may be formed so as to surround the whole of the laser oscillator 2110.

In FIG. 34, at the lower portion in the left side surface (one end surface in the X direction) of the side surface 2190b of the cover member 2190, that is, at the position closer to the workpiece setting region 2165 than the laser emission surface 2110a, an intake port (first air intake port) 2191 is formed. On the other hand, on the right side surface (the other end surface in the X direction) of the side surface 2190b, that is, on the lower portion in the surface provided opposite to the left side surface by sandwiching the workpiece setting region 2165, an air exhaust port 2192 is formed.

The air exhaust port 2192 is connected with the dust collection pump 2170. Hence, sucking force of the dust collection pump 2170 generates a flow of the dust collection air (first air) A1 from the air intake port 2191 flowing into the cover member 2190, that is, the laser irradiation space S and flowing out from the air exhaust port 2192. Since both of the air intake port 2191 and the air exhaust port 2192 are formed in the lower portion of the cover member 2190, most of the dust collection air A1 flows along the surface of the substrate 2120 disposed in the workpiece setting region 2165.

That is, the dust collection air A1 prevents the processing debris particularly generated at the front surface side of the substrate 2120 from adhering to the front surface of the substrate 2120, and has a role of collecting them on the filter attached to the dust collection pump 2170. A1′ in FIG. 34 denotes the dust collection air A1 including the processing debris generated at the front surface side of the substrate 2120 and being sucked by the dust collection pump 2170.

As described above, according to the present embodiment, the dust collection air A1 flowing inside the cover member 2190 and the dust collection air A2 flowing through the flow path 2162 inside the movable stage 2160 can remove the processing debris generated in the front surface side and the rear surface side of the substrate 2120 as a workpiece. Consequently, even when the generating amount of the processing debris from the substrate 2120 is great, the adherence of the processing debris with both surfaces of the substrate 2120 can be effectively suppressed.

Further, since the dust collection air A1 flows through the lower layer distanced from the laser emission surface 2110a within the laser irradiation space S, some effect of suppressing the adherence of the processing debris, which is generated at the top surface side of the substrate 2120 and rises, with the laser emission surface 2110a can be obtained.

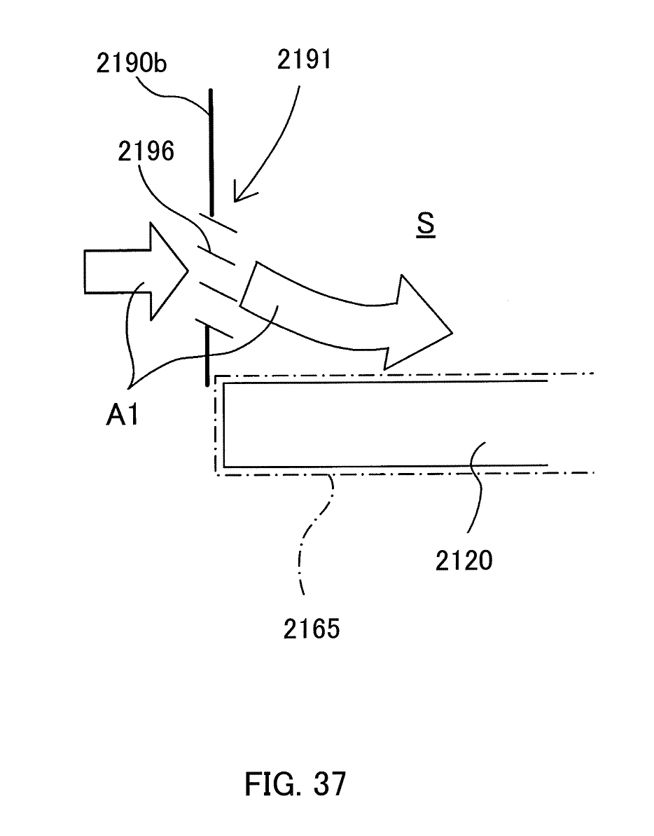

As shown in FIG. 37, the air intake port 2191 of the cover member 2190 may be provided with an air deflection member 2196 such as a louver which forcibly directs a flow of the dust collection air A1 toward the substrate 2120 (workpiece setting region 2165). As a result, the removal effect of the processing debris by the dust collection air A1 can be improved much more.

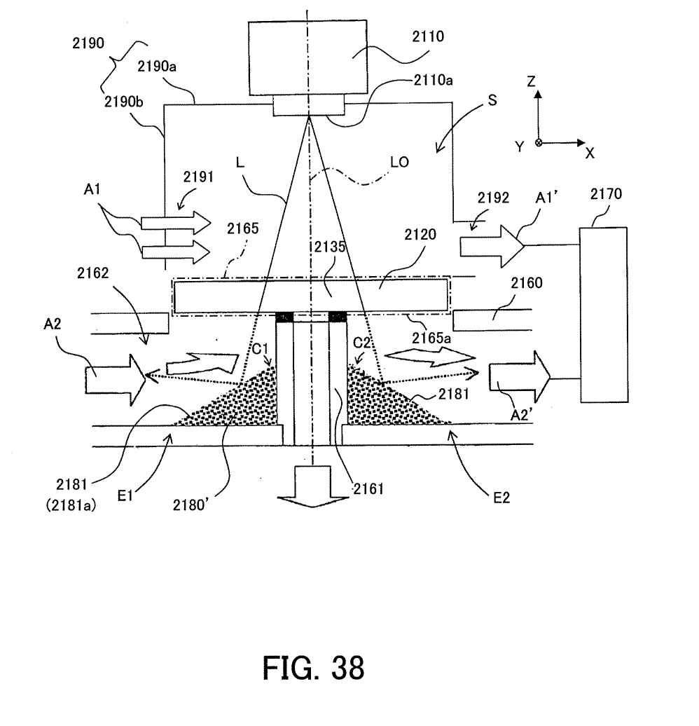

Further, as shown in FIG. 38, the top surface (front surface) 2181 of a laser receiving member 2180′ may be inclined so as to continuously approach the workpiece setting region 2165 from the external side portions E1 and E2 toward the inner side (center side) portions C1 and C2, that is, inclined so as to extend obliquely upward. The portions C1 and C2 are portions along the side surface of the adsorption head 2161. Further, in FIG. 38, the component parts common with the component parts shown in FIG. 34 are attached with the same reference numerals.

In FIG. 38, in other words, when the laser receiving surface 2181 is closer to the scanning center axis LO of the laser beam and the adsorption head 2161, it is inclined so as to continuously approach the workpiece setting region 2165.

In this case, in the left side portion (hereinafter, referred to as upstream side laser receiving surface) 2181a from the adsorption head 2161 within the laser receiving surface 2181, the upstream side laser receiving surface 2181a is inclined to gradually approach the workpiece setting region 2165 from the upstream side to the downstream side of the flow path 2162 (that is, a flow of the dust collection air A2). As a result, the sectional area of the flow path 2162 becomes gradually smaller across from the position of the external side portion E1 of the upstream side laser receiving surface 2181a to the position of the center side portion C1. Hence, the flow rate of the dust collection air A2 flowing therein increases toward the center side portion C1. Furthermore, a flow of the dust collection air A2 in the vicinity of the substrate 2120 is deflected to the substrate side by the guide function of the upstream side laser receiving surface 2181a. Consequently, the dust collection performance can be improved without changing the sucking ability of the dust collection pump 2170.

Furthermore, the increase of the flow rate of the dust collection air A2 flowing along the laser receiving surface 2180 can efficiently cool the laser receiving member 2180.

The laser beam L incident on the laser receiving surface 2181 after passing through the substrate 2120 (workpiece setting region 2165) is reflected in directions different from the workpiece setting region 2165 because the laser receiving surface 2181 is inclined. In other words, the angle of inclination of the laser receiving surface 2181 to the bottom surface (the workpiece setting reference surface) of the workpiece setting region 2165 and the rear surface of the substrate 2120 is set so that the laser beam L reflected on the laser receiving surface 1281 is not directed to the workpiece setting region 2165.

The surfaces of the laser receiving members 2180 and 2180′ shown in FIGS. 34 and 38 may be provided with a shape allowing the laser beam to be scatteringly reflected such as a matt shape and a shape of alternating ridges and valleys. In this case, in the laser receiving member 2180′ of FIG. 38, observing microscopically, it may be conceivable that the surface having the scattering shape continuously does not approach the workpiece setting region 2165. However, the laser receiving surface 2181 as a base surface of the surface having a scattering shape continuously approaches the workpiece setting region 2165. In the present embodiment, including such a case, it is defined that the laser receiving surface is inclined so as to continuously approach the workpiece setting region.

Further, the laser receiving surface 2181 of FIG. 38 is closest to the workpiece setting region 2165 in the center side portions C1 and C2, and the external side portions E1 and E2 are most away from the workpiece setting region 2165. In contrast to this, for example, the laser receiving surface may be formed as a one-way inclined surface continuously inclined from one end side to the other end side such that the one external side portion E1 is most away from the workpiece setting region 2165 and the other external side portion E2 is closest to the workpiece setting region 2165. Further, the laser receiving surface may be not limited to an inclined surface, but may be a curved surface such as a concave surface.

### Eighth Embodiment

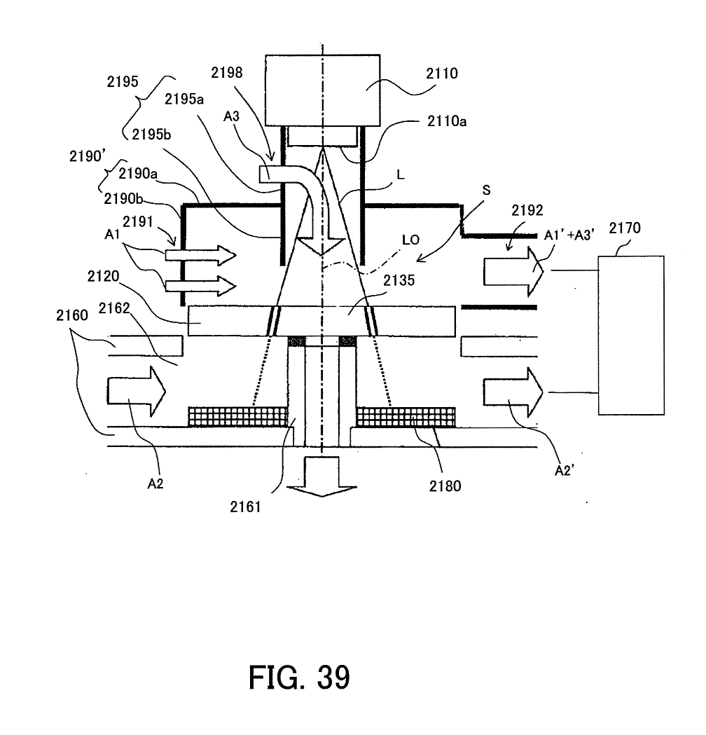

FIG. 39 shows the configuration of a laser cutting apparatus which is an eighth embodiment of the present invention. In FIG. 39, the component parts common with the component parts shown in FIG. 34 will be attached with the same reference numerals.

In the seventh embodiment, a description has been made on the case where the air intake portion 2191 and the air exhaust portion 2192 are provided at the positions closer to the workpiece setting region 2165 than to the laser emission surface 2110a in the cover member 2190. In the present embodiment, a cover member 2190′ integrated with an air-guiding member 2195 is further used, and an air intake portion (second air intake port) 2198 is provided also at a position closer to the laser emission surface 2110 than to the workpiece setting region 2165 within the air-guiding members 2195 (that is, cover member 2190′).

A top surface 2190a of the cover member 2190′ is distance downward from the laser emission surface 2110a as compared to the seventh embodiment, and the cover member 2190′ is formed such that the cylindrical air-guiding member 2195 penetrates the center of the top surface 2190a.

The upper side surface 2195a of the air-guiding member 2195 extends above from the top surface 2190a of the cover member 2190′ so as to surround the periphery of the laser emission surface 2110a. That is, the laser emission surface 2110a is exposed into the laser irradiation space S inside the cover member 2190′ including the inside of the air-guiding member 2195. Further, the lower side surface 2195b of the air-guiding member 2195 extends downward into the laser irradiation space S from the top surface 2190a of the cover member 2190′. Further, the upper side surface 2195a of the air-guiding member 2195 is formed with the air intake port 2198.

In the present embodiment also, similarly to the seventh embodiment, the air intake port 2191 and the air exhaust port 2192 are formed at a position closer to the workpiece setting region 2165 than to the laser emission surface 2110a of the cover member 2190′.

Hence, sucking force of the dust collection pump 2170, generates a flow of a dust collection air AT flowing into the cover member 2190′ from the air intake port 2191 and flowing out from the air exhaust part 2192, so that the processing debris generated on the front surface side of the substrate 2102 can be prevented from adhering to the front surface of the substrate 2120.

Further, in the present embodiment also, inside of the movable stage 2160 the flow path 2162 for a dust collection air A2 is formed so as to extend in the left and right (X direction) directions. Hence, sucking force of the dust collection pump 2170 generates a flow of the dust collection air A2 inside the flow path 2162, so that the processing debris generated at the rear surface side of the substrate 2120 can be prevented from adhering to the rear surface of the substrate 2120 and the surface of the laser receiving member 2180.

Further, in the present embodiment, the sucking force of the dust collection pump 2170 connected to the an exhaust port 2192 generates a flow of a dust collection air A3 flowing from the air intake port 2198 near the laser emission surface 2110a into the cover member 2190′ and flowing out from the air exhaust port 2192. The air-guiding member 2195 has a role of guiding this dust collection air A3 from the air exhaust port 2198 to the workpiece setting region side (that is, downward).

This downward flow of the dust collection air A3 prevents the processing debris generated on the front surface side of the substrate 2120 from rising inside the air-guiding member 2195 and reaching the laser emission surface 2110. Consequently, the processing debris is prevented from adhering to the laser emission surface 2110a, and a problem such as the laser beam L being blocked by the processing debris adhered to the laser emission surface 2110a can be avoided.

As described also in the seventh embodiment, the present embodiment has an effect that the dust collection air A1 flows through the lower layer of the laser irradiation space S, thereby suppressing the adherence of the processing debris to the laser emission surface 2110a. Further, the present embodiment can effectively prevent the adherence of the processing debris to the laser emission surface 2110a by generating a flow of the dust collection air A3 proceeding downward from the laser emission surface 2110a, even when a generated amount of the processing debris from the substrate 2110 is great.

A3′ in FIG. 34 denotes the dust collection air A3 including the processing debris generated on the front surface side of the substrate 2120 and being sucked by the dust collection pump 2170 from the air exhaust port 2192 common with the dust collection air A1 (A1′).

In the present embodiment also, the air deflection member 2196 and the laser receiving member 2180′ having an inclined laser receiving surface described by using FIGS. 37 and 38 in the seventh embodiment can be adopted.

According to the above described seventh and eighth embodiments, the processing debris generated on the workpiece front surface side can be removed by the first air flowing inside the cover member, and at the processing debris generated on the workpiece rear surface side can be removed by the second air. Consequently, even when a generated amount of the processing debris from the workpiece is great, the adherence thereof to both sides of the workpiece can be effectively suppressed.

Further, according to the above described seventh and eighth embodiments, since a flow of air from the laser emission surface side to the workpiece side is generated inside the cover member, even when the amount of processing debris generated from the workpiece is great, the adherence thereof to the laser emission surface can be effectively suppressed.

Furthermore, the present invention is not limited to these preferred embodiments and various variations and modifications may be made without departing from the scope of the present invention.

What is claimed is:

1. A semiconductor cutting apparatus which cuts a semiconductor substrate to cut out a semiconductor device with a laser beam, comprising:
a laser oscillator capable of outputting and scanning the laser beam;
a transport mechanism which causes the semiconductor substrate and the laser oscillator to relatively move; and
a controller which controls the laser oscillator and the transport mechanism;
wherein, when a plurality of semiconductor device regions each being surrounded by a predetermined cutting line are provided in the semiconductor substrate,
the controller controls the transport mechanism such that a scanning center of the laser beam of the laser oscillator is located above a position inner than the predetermined cutting line of each semiconductor device region and causes the laser oscillator to perform the scanning of the laser beam along the predetermined cutting line of the semiconductor device region.

2. The semiconductor cutting apparatus according to claim 1, wherein the inner position is a center or barycenter of the semiconductor device region.

3. The semiconductor cutting apparatus according to claim 1,
wherein the controller controls the transport mechanism such that the scanning center is sequentially moved with respect to the plurality of semiconductor device regions.

4. The semiconductor cutting apparatus according to claim 1, wherein the controller causes the laser oscillator to perform laser beam scanning in a plurality of times for the predetermined cutting line of each semiconductor device region.

5. A semiconductor device cutting system which cuts a semiconductor substrate along a predetermined cutting line to cut out a semiconductor device, the predetermined cutting line comprising a first portion having a straight line shape and a second portion having a shape different from the first portion, the system comprising:
a blade cutting part which cuts the semiconductor substrate along the first portion with a cutting blade; and
a laser cutting part which cuts the semiconductor substrate along the second portion with a laser beam.

6. The semiconductor device cutting system according to claim 5, wherein the second portion has a curved line shape.

7. The semiconductor device cutting system according to claim 5, wherein a plurality of the second portions are provided for a single semiconductor device, and
wherein the laser cutting part performs a process of sequentially cutting the plurality of the second portions by a predetermined depth in a plurality of times.

8. The semiconductor device cutting system according to claim 5, wherein the blade cutting part performs cutting of the first portion of the semiconductor substrate after the second portion thereof is cut by the laser cutting part.

9. The semiconductor device cutting system according to claim 5, wherein the semiconductor substrate includes a plurality of layers different in materials, and
wherein the laser cutting part irradiates a laser beam of the same wavelength for each of the layers in different frequencies.

10. A semiconductor cutting apparatus which cuts a semiconductor substrate having a plurality of semiconductor device regions with a laser beam, comprising:
a laser oscillator capable of outputting and scanning a laser beam; and
a controller which controls the laser oscillator so as to scan the laser beam along a predetermined cutting line of each semiconductor device region provided in the semiconductor substrate,
wherein the semiconductor substrate includes a plurality of layers mutually different in materials,
wherein the controller changes a parameter of the laser beam or the number of scanning times for each layer, and
wherein the controller causes the laser oscillator to perform an orbital scanning of the laser beam in a plurality of times for the same predetermined cutting line.

11. A laser cutting apparatus which cuts a workpiece set in a workpiece setting region with a laser beam, comprising:
a laser oscillator which emits a laser beam; and
a laser receiving member which receives the laser beam having passed through the workpiece setting region;
wherein the laser receiving member includes a laser receiving surface which approaches the workpiece setting region from an outer portion to an inner portion of the laser receiving member.

12. The laser cutting apparatus according to claim 11, wherein the laser receiving member is provided inside a flow path for a dust collection air,
wherein the laser receiving surface includes a surface which approaches the workpiece setting region from an upstream side to a downstream side of the flow of the dust collection air.

13. The laser cutting apparatus according to claim 11, wherein the workpiece is a semiconductor substrate, and the apparatus cuts the semiconductor device region formed in the workpiece.

14. A laser cutting apparatus which cuts a workpiece set in a workpiece setting region with a laser beam, comprising:
a laser oscillator capable of outputting and scanning a laser beam; and
a laser receiving member which receives the laser beam having passed through the workpiece setting region;
wherein the laser receiving member includes a laser receiving surface which approaches the workpiece setting region as approaching a scanning center axis of the laser beam.

15. The laser cutting apparatus according to claim 14, wherein the laser receiving member is provided inside the flow path for a dust collection air; and
wherein the laser receiving surface includes a surface which approaches the workpiece setting region from an upstream side to a downstream side of the flow of the dust collection air.

16. The laser cutting apparatus according to claim 14, wherein the workpiece is a semiconductor substrate, and the apparatus cuts the semiconductor device region formed in the workpiece.

17. A laser cutting apparatus which cuts a workpiece set in a workpiece setting region with a laser beam, comprising:
a laser oscillator which emits a laser beam; and
a cover member which surrounds a laser irradiation space between a laser emitting surface from which the laser beam emerges in the laser oscillator and the workpiece setting region,
wherein the cover member includes a first air intake port for taking in a first air and an air exhaust port for exhausting the first air, and
wherein the first air intake port and the air exhaust port are provided in the cover member at positions opposite to each other across the workpiece setting region and closer to the workpiece setting region than to the laser emitting surface,
wherein a flow path for a second air is formed on the opposite side to the laser irradiation space with respect to the workpiece setting region.

18. The laser cutting apparatus according to claim 17, wherein the cover member includes a second air intake port for taking in a third air which is guided by an air-guiding member inside of the cover member from a laser emission surface side to a workpiece setting region side.
